(19) United States
(12) Patent Application Publication
(10) Pub. No.: US 2021/0047916 A1
(43) Pub. Date: Feb. 18, 2021

(54) DAS Data Processing to Characterize Fluid Flow

(71) Applicants: BP Exploration Operating Company Limited, Middlesex (GB); BP Corporation North America, Inc., Houston, TX (US)

(72) Inventors: Pradyumna THIRUVENKATANATHAN, London (GB); Fei CAO, Houston, TX (US)

(73) Assignee: BP Corporation North America, Inc., Houston, TX (US)

(21) Appl. No.: 16/992,315

(22) Filed: Aug. 13, 2020

(30) Foreign Application Priority Data
Aug. 16, 2019 (US) PCT/US2019/046759

(51) Int. Cl. E21B 47/107; E21B 47/135; G01H 9/00; G01V 1/30; G01V 1/28

(52) U.S. Cl. CPC E21B 47/107; E21B 47/135; G01V 2210/324; G01V 1/307; G01V 1/288; G01H 9/004

(57) ABSTRACT

A method of characterizing an inflow into a wellbore includes obtaining an acoustic signal from a sensor within the wellbore. In addition, the method includes determining a plurality of frequency domain features from the acoustic signal. Further, the method includes identifying at least one of a gas phase flow, an aqueous phase flow, or a hydrocarbon liquid phase flow using the plurality of the frequency domain features. The method also includes classifying a flow rate of the at least one of the gas phase flow, the aqueous phase flow, or the hydrocarbon liquid phase flow using the plurality of frequency domain features. The acoustic signal comprises acoustic samples across a portion of a depth of the wellbore.

### CROSS-REFERENCE TO RELATED APPLICATIONS

This application claims the benefit of and priority to International Application No. PCT/US2019/046759 filed Aug. 16, 2019 with the U.S. Receiving office and entitled “DAS Data Processing to Characterize Fluid Flow,” which is hereby incorporated herein by reference in its entirety for all purposes.

### STATEMENT REGARDING FEDERALLY SPONSORED RESEARCH OR DEVELOPMENT

Not applicable.

### BACKGROUND

Within a hydrocarbon production well, various fluids such as hydrocarbons, water, gas, and the like can be produced from the formation into the wellbore. Such production operations can result in the movement of the fluids in various downhole regions, including within the subterranean formation, from the formation into the wellbore, and within the wellbore itself. For example, some subterranean formations can release water that can be produced along with the hydrocarbons into the wellbore. Such water inflow can cause a number of problems including erosion, clogging of wells due to resulting sand inflow, contamination and damage of the surface equipment, and the like. Significant water production can result in the need to choke back production from the well to bring water production down to acceptable levels. This can lead to reduced oil production, and potentially result in a deferral of substantial amounts of the production from the well,

### BRIEF SUMMARY

In some embodiments, a method of characterizing an inflow into a wellbore comprises obtaining an acoustic signal from a sensor within the wellbore, determining a plurality of frequency domain features from the acoustic signal, identifying at least one of a gas phase flow, an aqueous phase flow, or a hydrocarbon liquid phase flow using the plurality of the frequency domain features, and classifying a flow rate of the at least one of the gas phase flow, the aqueous phase flow, or the hydrocarbon liquid phase flow using the plurality of frequency domain features. The acoustic signal comprises acoustic samples across a portion of a depth of the wellbore.

In some embodiments, a method of developing a fluid flow characterization model for a wellbore comprises performing a plurality of flow tests, obtaining an acoustic signal from a sensor within the conduit for each flow test of the plurality of flow tests, wherein the acoustic signal comprises acoustic samples across a portion of the conduit, determining one or more frequency domain features from the acoustic signal for each of the plurality of fluid flow tests, and training a fluid flow characterization model using the one or more frequency domain features. Each flow test comprises introducing one or more fluids of a plurality of fluids into a flowing fluid within a conduit, and the plurality of fluids comprise a hydrocarbon gas, a hydrocarbon liquid, and an aqueous fluid, or a combination thereof. The fluid flow characterization model comprises a classification model that is configured to classify a flow rate of the hydrocarbon gas, the hydrocarbon liquid, and the aqueous fluid using the one or more frequency domain features.

In some embodiments, a method of characterizing fluid inflow into a wellbore comprises obtaining an acoustic signal from a sensor within the wellbore, determining a plurality of frequency domain features from the acoustic signal, and characterizing a flow rate of the at least one of the gas phase flow, the aqueous phase flow, or the hydrocarbon liquid phase flow using the plurality of frequency domain features. The acoustic signal comprises acoustic samples across a portion of a depth of the wellbore, and at least one of a gas phase flow, an aqueous phase flow, or a hydrocarbon liquid phase flow are flowing within the wellbore when the acoustic signal is obtained.

In some embodiments, a system for characterizing an inflow into a wellbore comprises a sensor within the wellbore and a controller coupled to the sensor. The controller is configured to: obtain an acoustic signal from the sensor, determine a plurality of frequency domain features from the acoustic signal, identify at least one of a gas phase flow, an aqueous phase flow, or a hydrocarbon liquid phase flow using the plurality of the frequency domain features, and classify a flow rate of the at least one of the gas phase flow, the aqueous phase flow, or the hydrocarbon liquid phase flow using the plurality of frequency domain features. The acoustic signal comprises acoustic samples across a portion of a depth of the wellbore.

In some embodiments, a system for characterizing an inflow into a wellbore comprises a sensor within the wellbore; and a controller coupled to the sensor. The controller is configured to: obtain an acoustic signal from the sensor when at least one of a gas phase flow, an aqueous phase flow, or a hydrocarbon liquid phase flow are flowing within the wellbore, determine a plurality of frequency domain features from the acoustic signal, and classify a flow rate of the at least one of the gas phase flow, the aqueous phase flow, or the hydrocarbon liquid phase flow using the plurality of frequency domain features. The acoustic signal comprises acoustic samples across a portion of a depth of the wellbore.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a flow diagram of a method of characterizing an inflow into a wellbore inflow according to some embodiments;

FIG. 2 is a schematic, cross-sectional illustration of a downhole wellbore environment according to some embodiments;

FIGS. 3A and 3B are a schematic, cross-sectional views of embodiments of a well with a wellbore tubular having an optical fiber inserted therein according to some embodiments;

FIG. 4 is a schematic view of an embodiment of a wellbore tubular with fluid inflow according to some embodiments;

FIG. 5 is an example frequency filtered acoustic intensity graph versus time over five frequency bands;

FIGS. 6A and 6B are example decision boundaries of one or more inflow characterization models according to some embodiments;

FIG. 7 is a generic representation of possible outputs produced according to some embodiments;

FIG. 8 is another generic representation of possible outputs produced according to some embodiments;

FIG. 9 illustrates a system for detecting the presence, type, and/or flow rate of fluid inflow according to some embodiments;

FIG. 10 is a flow diagram of a method of developing a fluid flow model according to some embodiments;

FIG. 11A is a schematic illustration of a flow loop assembly utilized to train an flow model according to some embodiments;

FIG. 11B is a schematic showing wellbore depths corresponding to injection points of FIG. 11A; and

FIG. 12 schematically illustrates a computer that may be used to carry out various methods according to some embodiments.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . “. Reference to up or down will be made for purposes of description with “up,” “upper,” “upward,” “upstream,” or “above” meaning toward the surface of the wellbore and with “down,” “lower,” “downward,” “downstream,” or “below” meaning toward the terminal end of the well, regardless of the wellbore orientation. Reference to inner or outer will be made for purposes of description with “in,” “inner,” or “inward” meaning towards the central longitudinal axis of the wellbore and/or wellbore tubular, and “out,” “outer,” or “outward” meaning towards the wellbore wall. As used herein, the term “longitudinal” or “longitudinally” refers to an axis substantially aligned with the central axis of the wellbore tubular, and “radial” or “radially” refer to a direction perpendicular to the longitudinal axis. The various characteristics mentioned above, as well as other features and characteristics described in more detail below, will be readily apparent to those skilled in the art with the aid of this disclosure upon reading the following detailed description of the embodiments, and by referring to the accompanying drawings.

As utilized herein, a ‘fluid inflow event’ includes fluid inflow (e.g., any fluid inflow regardless of composition thereof), gas phase inflow, aqueous phase inflow, and/or hydrocarbon phase inflow. The fluid can comprise other components such as solid particulate matter in some embodiments, as discussed in more detail herein.

As previously described, certain fluid production such as water inflow, sand inflow, and in some instances, gas inflow, within a hydrocarbon production well can result in the need to choke back production from the well which thereby leads to reduced hydrocarbon (e.g., oil, gas, etc.) production. Efforts have been made to detect the movement of various fluids including hydrocarbon liquids, water, and gas within the wellbore. For example, a production logging system utilizing a Production Logging System (PLS) tool can be employed to determine flow profile in wells. A PLS is generally an intervention tool that is temporarily placed in the wellbore and can be utilized to assess what fluids (oil/water/gas) are present in a well at the depth of the PLS, and what fluid is inflowing. A PLS can also provide data regarding what the flow rate of inflowing fluid passing the PLS is and some qualitative information on the flow regime (e.g., slug flow, bubble flow, etc.).

A typical PLS utilizes capacitive and resistive sensors to assess whether the inflowing fluid comprises oil, water, or gas, and flow meters (e.g., “spinners”) to measure an inflow rate. The sensors can be distributed around the circumference of the PLS so that the fluid profile and inflow rate can be assessed circumferentially. Thus, information on the background flow profile, inflow profile, background flow rate and inflow flow rate and flow regime can be obtained with a PLS.

A PLS tool is typically run through a well once or a few times (down and then up once or a few times and then out of the well), so the sensors of the PLS are exposed to the conditions at a given depth for a relatively brief period of time. As a result, the PLS log is established based on that brief window of data, at a given moment in the life of the well. However, the PLS log may be used for many (e.g., five or ten) years due to the high cost of running a PLS tool into a well. Fluid characteristics within a well can change substantially over that time as the well ages, and/or a fluid may flow into a well erratically (e.g., off and on, slug flow, etc.). For example, the PLS may detect the presence of gas at a time when there is gas inflow at a certain depth, but that gas inflow may fluctuate significantly, sometimes even over the course of a few hours. Nevertheless, future decisions about the well may be based on the assumption that there is always that same amount of gas present. Thus, the use of PLSs has a number of limitations.

Other techniques can allow for the identification of an inflow location. For example, acoustic systems can be used to determine the location and types of inflows using acoustic signals, as described herein. These techniques can be extended to apply to sand ingress locations, types of fluids inflowing into a wellbore, fluid leak locations, an amount of fluid leaking, and the like. The identification can rely on the comparison of an event signature for each type of event that defines thresholds or ranges for a plurality of frequency domain features. This type of analysis is helpful to provide information about events in the wellbore, but it may not provide full information on the flow volumes across the wellbore in real time. For example, simply knowing the location of a fluid inflow and even the type of fluid inflowing may not provide information on the quantity of fluid segregated by phase being produced in each zone in a wellbore.

Accordingly, embodiments disclosed herein provide systems and methods of continuously determining fluid inflow locations, as well as determining a fluid flow type and flow rate, which can be performed by classifying the fluid type and flow rate and/or through a model such as a regression model within a hydrocarbon production well. Specifically, disclosed herein is a new signal processing architecture that allows for the identification of fluid inflow locations, fluid inflow (or fluid flow) discrimination, and fluid flow rate determination (e.g., through classification and or prediction using a model) in real time or near real time within a conduit such as a wellbore. As utilized herein, “fluid flow discrimination” indicates an identification and/or assignment of the detected fluid flow (e.g., single phase flow, mixed phase flows, time based slugging, altering fluid flows, etc.), gas inflow, hydrocarbon liquid (e.g., ‘oil’) inflow, and/or aqueous phase (e.g., water) inflow, including any combined or multiphase flows or inflows. The methods of this disclosure can thus be utilized to provide information on various flow events such as a fluid ingress point as well as flow regimes, and flow rates within a conduit rather than simply a location at which gas, water, or hydrocarbon liquid is present in the wellbore tubular (e.g., present in a flowing fluid), which can occur at any point above the ingress location as the fluid flows to the surface of the wellbore.

In some instances, the systems and methods can provide information in real time or near real time. As used herein, the term “real time” refers to a time that takes into account various communication and latency delays within a system, and can include actions taken within about ten seconds, within about thirty seconds, within about a minute, within about five minutes, or within about ten minutes of the action occurring. Various sensors (e.g., distributed fiber optic acoustic sensors, point sensors, etc.) can be used to obtain an acoustic sampling at various points along the wellbore. The acoustic sample can then be processed using signal processing architecture with various feature extraction techniques (e.g., spectral feature extraction techniques) to obtain a measure of one or more frequency domain features and/or combinations thereof that enable selectively extracting the acoustic signals of interest from background noise and consequently aiding in improving the accuracy of the identification and characterization of fluids within the wellbore (e.g., flow rate classification of gas inflow, water inflow, hydrocarbon liquid inflow, etc.) in real time. While discussed in terms of being real time in some instances, the data can also be analyzed at a later time at the same location and/or a displaced location.

As used herein, various frequency domain features can be obtained from the acoustic signal, and in some contexts, the frequency domain features can also be referred to herein as spectral features or spectral descriptors. The frequency domain features are features obtained from the frequency domain analysis of the acoustic signals obtained within the wellbore, where the acoustic signal can be further resolved into depth intervals or sections using time of flight measurements from returned or reflected signals in an optical fiber. The frequency domain features can be derived from the full spectrum of the frequency domain of the acoustic signal such that each of the frequency domain features can be representative of the frequency spectrum of the acoustic signal. Further, a plurality of different frequency domain features can be obtained from the same acoustic signal, where each of the different frequency domain features is representative of frequencies across the same frequency spectrum of the acoustic signal as the other frequency domain features. For example, the frequency domain features (e.g., each frequency domain feature) can be statistical shape measurement or spectral shape function of the spectral power measurement across the same frequency bandwidth of the acoustic signal. Further, as used herein, frequency domain features can also refer to features or feature sets derived from one or more frequency domain features, including combinations of features, mathematical modifications to the one or more frequency domain features, rates of change of the one or more frequency domain features, and the like.

In some embodiments, the spectral features can comprise other features, including those in the time domain, various transforms (e.g., wavelets, Fourier transforms, etc.), and/or those derived from portions of the acoustic signal or other sensor inputs. Such other features can be used on their own or in combination one or more frequency domain features, including in the development of transformations of the features, as described in more detail herein.

In some embodiments, the acoustic signal(s) can be obtained in a manner that allows for a signal to be obtained along the entire wellbore or a portion of interest. Specifically, some embodiments may make use of fiber optic distributed acoustic sensors (DAS) to capture acoustic signals resulting from downhole events such as gas inflow/flow, hydrocarbon liquid inflow/flow, water inflow/flow, mixed flow, and the like, as well as other background acoustics, along an entire length or some designated length of the wellbore. After applying suitable signal processing procedures (e.g,, such as those described herein), fluid inflow and flow signals may be distinguished from other noise sources to properly identify and characterize each type of event.

The ability to identify and characterize various fluid inflow events (e.g., in terms of location, fluid type, and flow rate, etc.) in the wellbore may allow for various actions to be taken in response to the events. For example, a well can be shut in, production can be increased or decreased, and/or remedial measures can be taken in the wellbore, as appropriate based on the identified event(s). An effective response, when needed, benefits not just from a binary yes/no output of an identification of in-well events but also from a measure of an amount of fluids (e.g., amount of gas inflow, amount of hydrocarbon liquid inflow, amount of water inflow, etc.) from each of the identified zones of fluid inflow so that zones contributing the greatest fluid amount(s) can be acted upon first to improve or optimize production. The systems and methods described herein can be used to identify the source of the problem, a direction and amount of flow, and/or an identification of the type of problem being faced. For example, when a water inflow location is detected, a flow rate (e.g., such as a classified flow rate range) of the hydrocarbon liquid at the water inflow location may allow for a determination of whether or not to remediate, the type or method of remediation, the timing for remediation, and/or deciding to alter (e.g., reduce) a production rate from the well. For example, production zones can be isolated, production assemblies can be open, closed, or choked at various levels, side wells can be drilled or isolated, and the like. Such determinations can be used to improve on the drawdown of the well while reducing the production expenses associated with various factors such as produced water. Various specific embodiments of system and methods are now described for continuously determining fluid inflow locations, as well as classifying the fluid type and flow rate within a hydrocarbon production well with reference to the Figures.

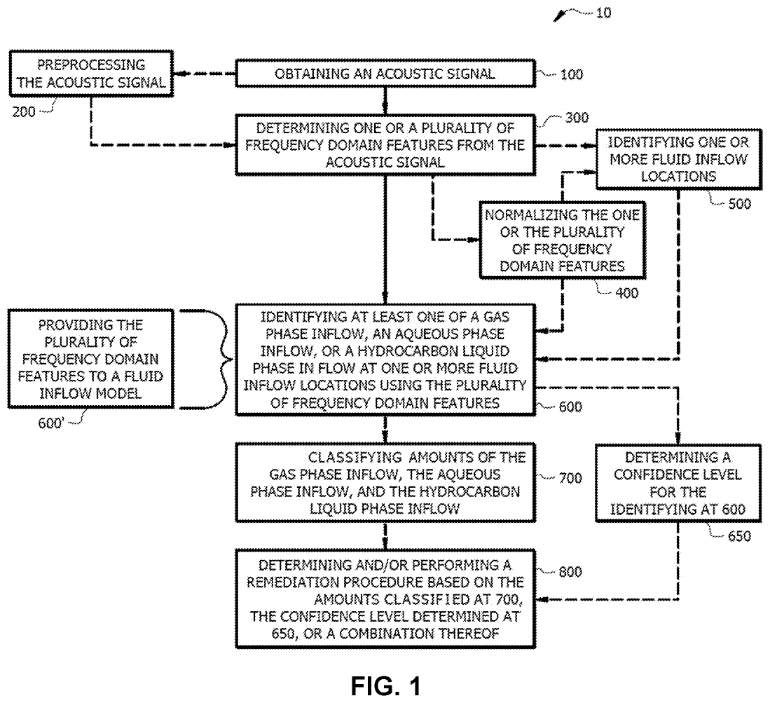

Referring now to FIG. 1, a flow chart of a method 10 of characterizing a fluid flow and/or inflow according to some embodiments of this disclosure is shown. As described herein, the methods and systems can be used to identify fluid flow. As used herein fluid flow can comprise fluid flow along or within a tubular within the wellbore such as fluid flow within a production tubular. Fluid flow can also comprise fluid flow from the reservoir or formation into a wellbore tubular and/or an annular space between the wellbore tubular and the formation face. Such flow into the wellbore and/or a wellbore tubular can be referred to as fluid inflow. While fluid inflow may be separately identified at times in this disclosure, such fluid inflow is considered a part of fluid flow within the wellbore.

Generally speaking, method 10 may comprise obtaining an acoustic signal along the wellbore at 100 and determining one or a plurality of frequency domain features from the acoustic signal at 300. In some embodiments, method 10 includes identifying one or more fluid inflow locations at 500. In some embodiments, method 10 includes determining fluid inflow discrimination—namely identifying at least one of a gas phase inflow, an aqueous phase inflow, or a hydrocarbon liquid phase inflow at one or more fluid inflow locations using the plurality of frequency domain features at 600. When used to identify flow regimes, the method can include identifying at least one of a gas phase flow, an aqueous phase flow, and/or a hydrocarbon liquid phase flow at one or more locations in the wellbore.

As depicted in FIG. 1, in some embodiments method 10 may comprise preprocessing the acoustic signal at 200 prior to determining the one or the plurality of frequency domain features from the acoustic signal at 300. In addition, in some embodiments, method 10 may comprise normalizing the one or the plurality of frequency domain features at 400, prior to identifying the one or more fluid flow locations at 500 and/or identifying the at least one of the gas phase flow, an aqueous phase flow, and/or a hydrocarbon liquid phase flow at one or more fluid flow locations, including in some embodiments inflow locations, using the plurality of frequency domain features at 600.

Identifying the at least one of the gas phase flow, the aqueous phase flow, or the hydrocarbon liquid phase flow at the one or more fluid flow locations (e.g., into the wellbore, along a tubular, inflow locations, etc.) using the plurality of frequency domain features at 600 may comprise providing the plurality of frequency domain features to a fluid flow model as indicated at 600′, where embodiments of the model are described in more detail below. In some embodiments, method 10 may further comprise, at 650, determining a confidence level for the identifying at 600. In addition, in some embodiments, method 10 may comprise determining and/or classifying amounts of the gas phase flow, the aqueous phase flow, and the hydrocarbon phase flow at 700 prior to determining at 800 a remediation procedure based on the relative amounts of the gas phase flow, the aqueous phase flow, and the hydrocarbon phase flow determined at 700 and/or the confidence level determined at 650. As described in more detail below, “classifying amounts” may refer to determining or classifying an amount of the different flow types (e.g., gas, aqueous, hydrocarbon, etc.). In some embodiments, “classifying amounts” may comprise classifying a flow rate (or a flow rate range) for one or more or each of the flow types.

The features of method 10 are now described in more detail below. In describing method 10, reference will be made to additional figures herein so as to better explain various embodiments.

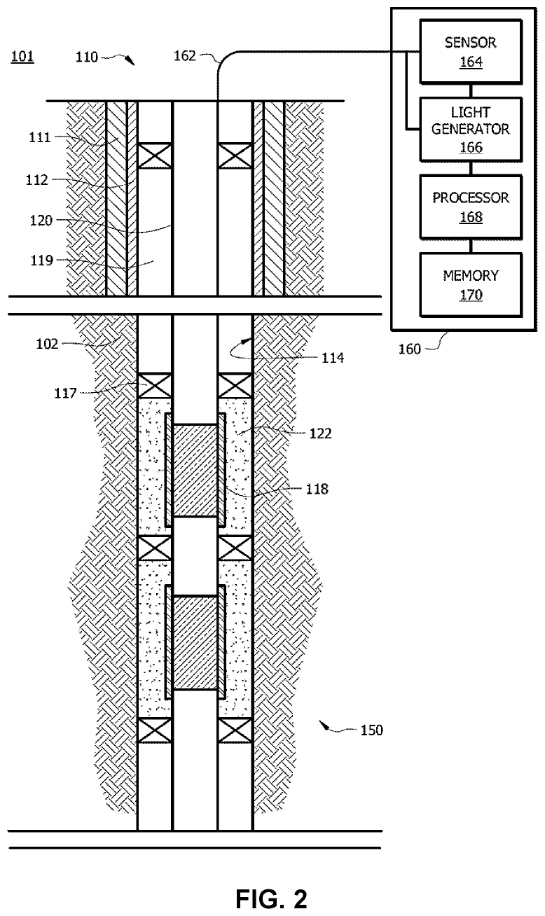

Initially, method 10 includes obtaining an acoustic signal at 100. Such an acoustic signal can be obtained via any suitable method. An example system and method for obtaining the acoustic signal at 100 will now be described with reference to FIG. 2, where a schematic, cross-sectional illustration of a downhole wellbore operating environment 101 according to some embodiments is shown.

More specifically, environment 101 includes a wellbore 114 traversing a subterranean formation 102, casing 112 lining at least a portion of wellbore 114, and a tubular 120 extending through wellbore 114 and casing 112. A plurality of completion assemblies such as spaced screen elements or assemblies 118 may be provided along tubular 120. In addition, a plurality of spaced zonal isolation device 117 and gravel packs 122 may be provided between tubular 120 and the sidewall of wellbore 114. In some embodiments, the operating environment 101 includes a workover and/or drilling rig positioned at the surface and extending over the wellbore 114 (not shown in FIG. 2). While FIG. 2 shows an example completion configuration in FIG. 2, it should be appreciated that other configurations and equipment may be present in place of or in addition to the illustrated configurations and equipment.

In general, the wellbore 114 can be formed in the subterranean formation 102 using any suitable technique (e.g., drilling). The wellbore 114 can extend substantially vertically from the earth's surface over a vertical wellbore portion, deviate from vertical relative to the earth's surface over a deviated wellbore portion, and/or transition to a horizontal wellbore portion. In general, all or portions of a wellbore may be vertical, deviated at any suitable angle, horizontal, and/or curved. In addition, the wellbore 114 can be a new wellbore, an existing wellbore, a straight wellbore, an extended reach wellbore, a sidetracked wellbore, a multi-lateral wellbore, and other types of wellbores for drilling and completing one or more production zones. As illustrated, the wellbore 114 includes a substantially vertical producing section 150, which in this embodiment is an open hole completion (i.e., casing 112 does not extend through producing section 150). Although section 150 is illustrated as a vertical and open hole portion of wellbore 114 in FIG. 1, embodiments disclosed herein can be employed in sections of wellbores having any orientation, and in open or cased sections of wellbores. The casing 112 extends into the wellbore 114 from the surface and can be secured within the wellbore 114 with cement 111.

The tubular 120 may comprise any suitable downhole tubular or tubular string (e.g., drill string, casing, liner, jointed tubing, and/or coiled tubing, etc.), and may be inserted within wellbore 114 for any suitable operation(s) (e,g., drilling, completion, intervention, workover, treatment, production, etc.). In the embodiment shown in FIG. 2, the tubular 120 is a completion assembly string. In addition, the tubular 120 may be disposed within in any or all portions of the wellbore 114 (e.g., vertical, deviated, horizontal, and/or curved section of wellbore 114).

In this embodiment, the tubular 120 extends from the surface to the producing zones and generally provides a conduit for fluids to travel from the formation 102 to the surface. A completion assembly including the tubular 120 can include a variety of other equipment or downhole tools to facilitate the production of the formation fluids from the production zones. For example, zonal isolation devices 117 can be used to isolate the various zones within the wellbore 114. In this embodiment, each zonal isolation device 117 comprises a packer (e.g., production packer, gravel pack packer, frac-pac packer, etc.). The zonal isolation devices 117 can be positioned between the screen assemblies 118, for example, to isolate different gravel pack zones or intervals along the wellbore 114 from each other. In general, the space between each pair of adjacent zonal isolation devices 117 defines a production interval.

The screen assemblies 118 provide sand control capability. In particular, the sand control screen elements 118, or other filter media associated with wellbore tubular 120, can be designed to allow fluids to flow therethrough but restrict and/or prevent particulate matter of sufficient size from flowing therethrough. The screen assemblies 118 can be of the type known as “wire-wrapped”, which are made up of a wire closely wrapped helically about a wellbore tubular, with a spacing between the wire wraps being chosen to allow fluid flow through the filter media while keeping particulates that are greater than a selected size from passing between the wire wraps. Other types of filter media can also be provided along the tubular 120 and can include any type of structures commonly used in gravel pack well completions, which permit the flow of fluids through the filter or screen while restricting and/or blocking the flow of particulates (e.g. other commercially-available screens, slotted or perforated liners or pipes; sintered-metal screens; sintered-sized, mesh screens; screened pipes; prepacked screens and/or liners; or combinations thereof). A protective outer shroud having a plurality of perforations therethrough may be positioned around the exterior of any such filter medium.

The gravel packs 122 are formed in the annulus 119 between the screen elements 118 (or tubular 120) and the sidewall of the wellbore 114 in an open hole completion. In general, the gravel packs 122 comprise relatively coarse granular material placed in the annulus to form a rough screen against the ingress of sand into the wellbore while also supporting the wellbore wall. The gravel pack 122 is optional and may not be present in all completions.

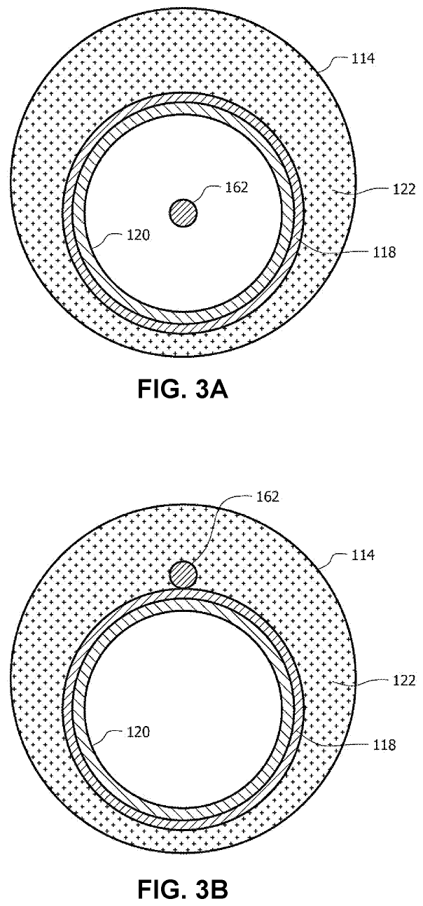

Referring still to FIG. 2, a DAS system 110 can be coupled to tubular 120. In particular, the DAS system 110 comprises an optical fiber 162 that is coupled to and extends along tubular 120. In cased completions, the optical fiber 162 can be installed between the casing and the wellbore wall within a cement layer and/or installed within the casing or production tubing. Referring briefly to FIGS. 3A and 3B, optical fiber 162 of DAS system 110 may be coupled to an exterior of tubular 120 (e.g., such as shown in FIG. 3B) or an interior of tubular (e.g., such as shown in FIG. 3A). When the optical fiber 162 is coupled to the exterior of the tubular 120, as depicted in the embodiment of FIG. 3B, the optical fiber 162 can be positioned within a control line, control channel, or recess in the tubular 120. In some embodiments an outer shroud contains the tubular 120 and protects the optical fiber 162 during installation. A control line or channel can be formed in the shroud and the optical fiber 162 can be placed in the control line or channel (not specifically shown in FIGS. 3A and 3B).

Referring again to FIG. 2, generally speaking, during operations optical backscatter component of light injected into the optical fiber 162 may be used to detect acoustic perturbations (e.g., dynamic strain) along the length of the fiber 162. The light can be generated by a light generator or source 166 such as a laser, which can generate light pulses. Accordingly, the optical fiber 162 acts as the sensor element with no additional transducers in the optical path, and measurements can be taken along the length of the entire optical fiber 162. The measurements can then be detected by an optical receiver such as sensor 164 and selectively filtered to obtain measurements from a given depth point or range, thereby providing for a distributed measurement that has selective data for a plurality of zones along the optical fiber 162 at any given time. For example, time of flight measurements of the backscattered light can be used to identify individual zones or measurement lengths of the fiber optic 162. In this manner, the optical fiber 162 effectively functions as a distributed array of microphones spread over the entire length of the optical fiber 162, which typically spans at least the production zone 150 of the wellbore 114, to detect downhole acoustic signals.

The light backscattered up the optical fiber 162 as a result of the optical backscatter can travel back to the source, where the signal can be collected by a sensor 164 and processed (e.g., using a processor 168). In general, the time the light takes to return to the collection point is proportional to the distance traveled along the optical fiber 162, thereby allowing time of flight measurements of distance along the optical fiber. The resulting backscattered light arising along the length of the optical fiber 162 can be used to characterize the environment around the optical fiber 162. The use of a controlled light source 166 (e.g., having a controlled spectral width and frequency) may allow the backscatter to be collected and any disturbances along the length of the optical fiber 162 to be analyzed. In general, any acoustic or dynamic strain disturbances along the length of the optical fiber 162 can result in a change in the properties of the backscattered light, allowing for a distributed measurement of both the acoustic magnitude (e.g., amplitude), frequency and, in some cases, of the relative phase of the disturbance. Any suitable detection methods including the use of highly coherent light beams, compensating interferometers, local oscillators, and the like can be used to produce one or more signals that can be processed to determine the acoustic signals or strain impacting the optical fiber along its length.

An acquisition device 160 may be coupled to one end of the optical fiber 162 that comprises the sensor 164, light generator 166, a processor 168, and a memory 170. As discussed herein, the light source 166 can generate the light (e.g., one or more light pulses), and the sensor 164 can collect and analyze the backscattered light returning up the optical fiber 162. In some contexts, the acquisition device 160 (which comprises the light source 166 and the sensor 164 as noted above), can be referred to as an interrogator. The processor 168 may be in signal communication with the sensor 164 and may perform various analysis steps described in more detail herein. While shown as being within the acquisition device 160, the processor 168 can also be located outside of the acquisition device 160 including being located remotely from the acquisition device 160. The sensor 164 can be used to obtain data at various rates and may obtain data at a sufficient rate to detect the acoustic signals of interest with sufficient bandwidth. While described as a sensor 164 in a singular sense, the sensor 164 can comprise one or more photodetectors or other sensors that can allow one or more light beams or reflections to be detected for further processing. In an embodiment, depth resolution ranges in a range of from about 1 meter to about 10 meters, or less than or equal to about 10, 9, 8, 7, 6, 5, 4, 3, 2, or 1 meter can be achieved. Depending on the resolution needed, larger averages or ranges can be used for computing purposes. When a high depth resolution is not needed, a system may have a wider resolution (e.g., which may be less expensive) can also be used in some embodiments. Data acquired by the DAS system 110 (e.g., via fiber 162, sensor 164, etc.) may be stored on memory 170.

While the system 101 described herein can be used with a DAS system (e.g., DAS system 110) to acquire an acoustic signal for a location or depth range in the wellbore 114, in general, any suitable acoustic signal acquisition system can be used in performing embodiments of method 10 (see e.g., FIG. 1). For example, various microphones, geophones, hydrophones, or other sensors can be used to provide an acoustic signal at a given location based on the acoustic signal processing described herein. Further, an optical fiber comprising a plurality of point sensors such as Bragg gratings can also be used. As described herein, a benefit of the use of the DAS system 110 is that an acoustic signal can be obtained across a plurality of locations and/or across a continuous length of the wellbore 114 rather than at discrete locations.

During operations, the fluid flowing into the tubular 120 may comprise more than one fluid component. Typical components include natural gas, oil (e.g., hydrocarbon liquids), water, steam, carbon dioxide, and/or various multiphase mixed flows. The fluid flow can further be time varying such as including slugging, bubbling, or time altering flow rates of different phases. The amounts or flow rates of these components can vary over time based on conditions within the formation 102 and the wellbore 114. Likewise, the composition of the fluid flowing into the tubular 120 sections throughout the length of the entire production string can vary significantly from section to section at any given time.

Fluid can be produced into the wellbore 114 and into the completion assembly string. As the fluid enters the wellbore 114, it may create acoustic sounds that can be detected using an acoustic sensor such as a DAS system (e.g., fiber 162). Accordingly, the flow of the various fluids into the wellbore 114 and/or through the wellbore 114 can create vibrations or acoustic sounds that can be detected using DAS system 110. Each type of event such as the different fluid flows and fluid flow locations can produce an acoustic signature with unique frequency domain features.

Specific spectral signatures can be determined for each event by considering one or more frequency domain features of the acoustic signal obtained from the wellbore. More specifically, each event can have a characteristic set of frequency domain features, or combinations thereof (e.g., an acoustic or spectral signature), that fall within certain thresholds as defining the event. The resulting spectral signatures can then be used along with processed acoustic signal data to detect and/or characterize an event at a depth range of interest by matching the detected frequency domain features to the acoustic signature(s). The events can include various fluid and/or particulate flows and/or inflows as described herein. The spectral signatures can be determined by considering the different types of flow occurring within a wellbore and characterizing the frequency domain features for each type of flow. In some embodiments, various combinations and/or transformations of the frequency domain features can be used to characterize each type of flow. Further, in some embodiments, the frequency domain features may further be used to classify a flow rate of each identified type of flow,

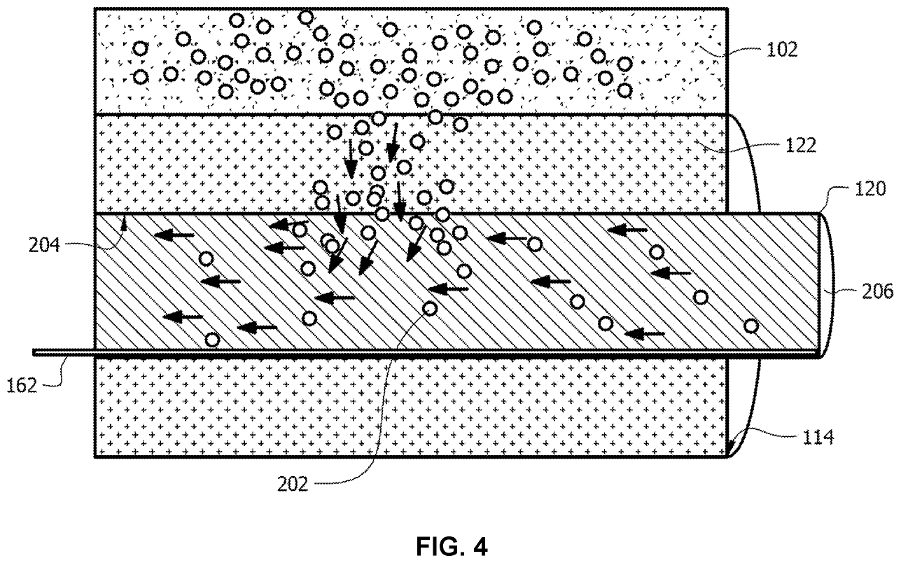

FIG. 4 schematically illustrates wellbore tubular 120 from FIG. 2 with fluid inflow including a gas phase (e.g., as depicted as gas bubbles 202) with or without a liquid phase. The gas phase depicted as 202 can flow from the formation 102 into the wellbore 114 and then into the tubular 120. As the fluid 202 flows into the tubular 120, various acoustic signals can be generated, and as the fluid 202 flows within the tubular 120, additional acoustic signals, which can be the same or different than the inflow signals, can also be generated. The acoustic signals can then be detected by the optical fiber 162 and recorded using the DAS system 110 (see e.g., FIG. 2). Without being limited by this or any particular theory, the spectral characteristics of the sounds generated by each type of fluid flow and/or inflow can depend on the effective mass and flow rate of each fluid. In some embodiments, the acoustic signals obtained at 100 can include frequencies in the range of about 5 Hz to about 10 kHz, frequencies in the range of about 5 Hz to about 5 kHz or about 50 Hz to about 5 kHz, or frequencies in the range of about 500 Hz to about 5 kHz. Any frequency ranges between the lower frequencies values (e.g., 5 Hz, 50 Hz, 500 Hz, etc.) and the upper frequency values (e.g., 10 kHz, 7 kHz, 5 kHz, etc.) can be used to define the frequency range for a broadband acoustic signal.

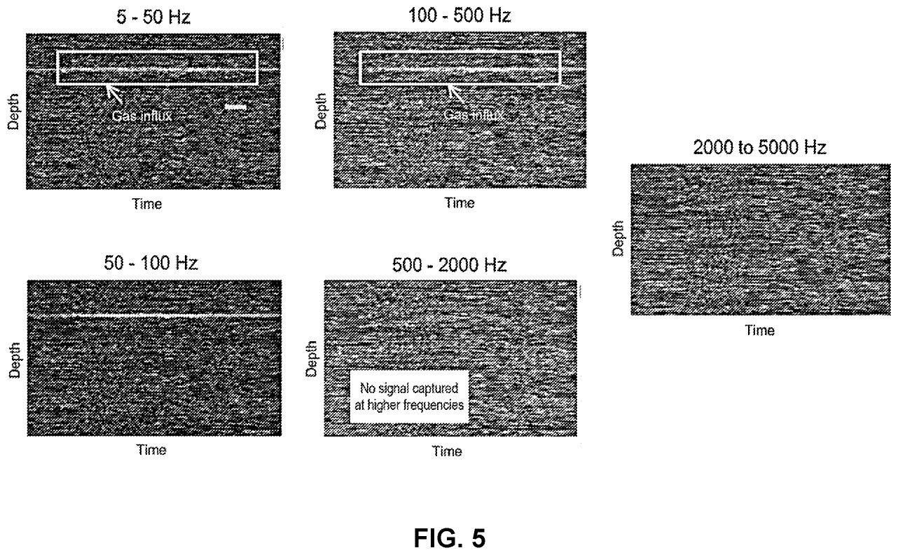

Taking gas flow and/or inflow as an example (e.g., such as shown in FIG. 4), the proximity to the optical fiber 162 to the flow/inflow can result in a high likelihood that any generated acoustic signals would be detected by the optical fiber 162. The flow of a gas into the wellbore would likely result in a turbulent flow over a broad frequency range. For example, the gas inflow acoustic signals can be between about 0 Hz and about 1000 Hz, or alternatively between about 0 Hz and about 500 Hz. An increased power intensity may occur between about 300 Hz and about 500 Hz from increased turbulence in the gas flow. An example of the acoustic signal resulting from the influx of gas into the wellbore is shown in FIG. 5, which illustrates frequency filtered acoustic intensity in depth versus time graphs for five frequency bins. As illustrated, the five frequency bins represent 5 Hz to 50 Hz, 50 Hz to 100 Hz, 100 Hz to 500 Hz, 500 Hz to 2000 Hz, and 2000 Hz to 5000 Hz. The acoustic intensity can be seen in the first three bins with frequency ranges up to about 500 Hz, with a nearly undetectable acoustic intensity in the frequency range above 500 Hz. This demonstrates that at least a portion of the frequency domain features may not be present above 500 Hz, which can help to define the signature of the influx of gas. This type of response demonstrates that each event can be expected to produce an acoustic response having potentially unique feature sets that can be used to help define a signature for the event. While described in terms of frequency ranges or bins, other features and transformations of such features can be used to help define the gas flow and/or inflow signatures, which can be used with a multivariate model for determining if gas flow and/or inflow is present.

Similar frequency features can be expected for other fluid inflows as well as fluid flows along a tubular within the wellbore. The resulting acoustic signal can be processed to determine a plurality of frequency domain features. The acoustic signatures for each type of fluid flow can then be based on a plurality of frequency domain features. This can include transforming one or more of the frequency domain features to serve as an element of a specific fluid flow signature, as described in more detail herein.

Referring again to FIG. 2, the processor 168 within the acquisition device 160 may be configured to perform various data processing to detect the presence of fluid inflow along the length of the wellbore 114 (more specifically along the length of optical fiber 162). For instance, the memory 170 may be configured to store an application or program (e.g., comprising machine-readable instructions, such as, for instance, non-transitory machine-readable instructions) to perform the data analysis. While shown as being contained within the acquisition device 160, the memory 170 can comprise one or more memories, any of which can be external to the acquisition device 160. In some embodiments, the processor 168 can execute the application, which can configure the processor 168 to filter the acoustic data set spatially, determine one or more frequency domain features of the acoustic signal. In addition, the processor 168 (as a result of executing the application) may further determine whether or not fluid inflow is occurring at the selected location based on the analysis described hereinbelow, whether any fluid inflow comprises water inflow, hydrocarbon liquid inflow, and gas inflow, and whether the fluid inflow has a flow rate within one of a plurality of defined flow rate ranges. The analysis can be repeated across various locations along the length of the wellbore 114 to determine the locations of fluid inflow, the type of fluid (e.g., gas, water, hydrocarbon liquid) inflowing, and the flow rate classification of fluid inflow (e.g,, for each fluid inflow type as previously described above) along the length of the wellbore 114.

Referring again to FIG. 1, after the acoustic signal is obtained at 100, method 10 may proceed, in some embodiments, to pre-process the raw data at 200. The acoustic signal can be generated within the wellbore as previously described. Depending on the type of DAS system employed (e.g., DAS system 110 in FIG. 2), the optical data may or may not be phase coherent and may be pre-processed to improve the signal quality (e.g., denoised for opto-electronic noise normalization/de-trending single point-reflection noise removal through the use of median filtering techniques or even through the use of spatial moving average computations with averaging windows set to the spatial resolution of the acquisition unit, etc.). The raw optical data from the acoustic sensor can be received, processed, and generated by the sensor to produce the acoustic signal. The data rate generated by various acoustic sensors such as the DAS system can be large. For example, the DAS system may generate data on the order of 0.5 to about 2 terabytes per hour. This raw data can optionally be stored in a memory (e.g., memory 170 for DAS system 110 in FIG. 2).

A number of specific processing steps can be performed to determine the presence of fluid inflow, the composition of inflowing fluid, and to classify the flow rate of the inflowing fluid. In some embodiments, a processor or collection of processors (e.g., processor 168 in FIG. 2) may be utilized to perform the preprocessing steps described herein. In an embodiment, the noise detrended “acoustic variant” data can be subjected to an optional spatial filtering step following the other pre-processing steps, if present. A spatial sample point filter can be applied that uses a filter to obtain a portion of the acoustic signal corresponding to a desired depth or depth range in the wellbore. Since the time the light pulse sent into the optical fiber returns as backscattered light can correspond to the travel distance, and therefore depth in the wellbore, the acoustic data can be processed to obtain a sample indicative of the desired depth or depth range. This may allow a specific location within the wellbore to be isolated for further analysis. The pre-processing at 200 may also include removal of spurious back reflection type noises at specific depths through spatial median filtering or spatial averaging techniques. This is an optional step and helps focus primarily on an interval of interest in the wellbore. For example, the spatial filtering step can be used to focus on a producing interval where there is maximum likelihood of fluid inflow, for example. The resulting data set produced through the conversion of the raw optical data can be referred to as the acoustic sample data.

Filtering can provide several advantages. For instance, when the acoustic data set is spatially filtered, the resulting data, for example the acoustic sample data, used for the next step of the analysis can be indicative of an acoustic sample over a defined depth (e.g., the entire length of the optical fiber, some portion thereof, or a point source in the wellbore 114). In some embodiments, the acoustic data set can comprise a plurality of acoustic samples resulting from the spatial filter to provide data over a number of depth ranges. In some embodiments, the acoustic sample may contain acoustic data over a depth range sufficient to capture multiple points of interest. In some embodiments, the acoustic sample data contains information over the entire frequency range of the detected acoustic signal at the depth represented by the sample. This is to say that the various filtering steps, including the spatial filtering, do not remove the frequency information from the acoustic sample data.

In some embodiments, the filtered data may be additionally transformed from the time domain into the frequency domain using a transform at 200 (e.g., after it has been filtered—such as spatially filtered as described above). For example, Discrete Fourier transformations (DFT) or a short time Fourier transform (STET) of the acoustic variant time domain data measured at each depth section along the fiber or a section thereof may be performed to provide the data from which the plurality of frequency domain features can be determined. The frequency domain features can then be determined from the acoustic data. Spectral feature extraction using the frequency domain features through time and space can be used to determine the spectral conformance (e.g., whether or not one or more frequency domain features match or conform to certain signature thresholds) and determine if an acoustic signature (e.g., a fluid inflow signature, a gas phase inflow signature, a water phase inflow signature, a hydrocarbon liquid phase inflow signature, etc.) is present in the acoustic sample. Within this process, various frequency domain features can be calculated for the acoustic sample data.

Preprocessing at 200 can optionally include a noise normalization routine to improve the signal quality. This step can vary depending on the type of acquisition device used as well as the configuration of the light source, the sensor, and the other processing routines. The order of the aforementioned preprocessing steps can be varied, and any order of the steps can be used.

Preprocessing at 200 can further comprise calibrating the acoustic signal. Calibrating the acoustic signal can comprise removing a background signal from the acoustic signal, aligning the acoustic data with physical depths in the wellbore, and/or correcting the acoustic signal for signal variations in the measured data. In some embodiments, calibrating the acoustic signal comprises identifying one or more anomalies within the acoustic signal and removing one or more portions of the acoustic signal outside the one or more anomalies.

Following the preprocessing at 200, method 10 may determine one or a plurality of frequency domain features from the acoustic signal at 300. The use of frequency domain features to identify inflow locations, inflow discrimination, and inflow flow rate classification can provide a number of advantages. First, the use of frequency domain features results in significant data reduction relative to the raw DAS data stream. Thus, a number of frequency domain features can be calculated and used to allow for event identification while the remaining data can be discarded or otherwise stored, and the remaining analysis can performed using the frequency domain features. Even when the raw DAS data is stored, the remaining processing power is significantly reduced through the use of the frequency domain features rather than the raw acoustic data itself. Further, the use of the frequency domain features can, with the appropriate selection of one or more of the frequency domain features, provide a concise, quantitative measure of the spectral character or acoustic signature of specific sounds pertinent to downhole fluid surveillance and other applications.

While a number of frequency domain features can be determined for the acoustic sample data, not every frequency domain feature may be used in the identifying fluid flow characteristics, inflow locations, flow type, or flow rate classification or prediction. The frequency domain features represent specific properties or characteristics of the acoustic signals. There are a number of factors that can affect the frequency domain feature selection for each fluid inflow event. For example, a chosen descriptor should remain relatively unaffected by the interfering influences from the environment such as interfering noise from the electronics/optics, concurrent acoustic sounds, distortions in the transmission channel, and the like. In general, electronic/instrumentation noise is present in the acoustic signals captured on the DAS or any other electronic gauge, and it is usually an unwanted component that interferes with the signal. Thermal noise is introduced during capturing and processing of signals by analogue devices that form a part of the instrumentation (e,.g., electronic amplifiers and other analog circuitry). This is primarily due to thermal motion of charge carriers. In digital systems additional noise may be introduced through sampling and quantization. The frequency domain features should have values that are significant for a given event in the presence of noise.

As a further consideration in selecting the frequency domain feature(s) for a fluid inflow event in some embodiments, the dimensionality of the frequency domain feature should be compact. A compact representation may be desired to decrease the computational complexity of subsequent calculations. It may also be desirable for the frequency domain feature to have discriminant power. For example, for different types of audio signals, the selected set of descriptors should provide altogether different values. A measure for the discriminant power of a feature is the variance of the resulting feature vectors for a set of relevant input signals. Given different classes of similar signals, a discriminatory descriptor should have low variance inside each class and high variance over different classes. The frequency domain feature should also be able to completely cover the range of values of the property it describes.

In some embodiments, combinations of frequency domain features can be used. This can include a signature having multiple frequency domain features as indicators. In some embodiments, a plurality of frequency domain features can be transformed to create values that can be used to define various event signatures. This can include mathematical transformations including ratios, equations, rates of change, transforms (e.g., wavelets, Fourier transforms, other wave form transforms, etc.), other features derived from the feature set, and/or the like as well as the use of various equations that can define lines, surfaces, volumes, or multi-variable envelopes. The transformation can use other measurements or values outside of the frequency domain features as part of the transformation. For example, time domain features, other acoustic features, and non-acoustic measurements can also be used. In this type of analysis, time can also be considered as a factor in addition to the frequency domain features themselves. As an example, a plurality of frequency domain features can be used to define a surface (e.g., a plane, a three-dimensional surface, etc.) in a multivariable space, and the measured frequency domain features can then be used to determine if the specific readings from an acoustic sample fall above or below the surface. The positioning of the readings relative to the surface can then be used to determine if the event if present or not at that location in that detected acoustic sample.

As an example, the chosen set of frequency domain features should be able to uniquely identify the event signatures with a reasonable degree of certainty of each of the acoustic signals pertaining to a selected downhole surveillance application or fluid inflow event as described herein. Such frequency domain features can include, but are not limited to, the spectral centroid, the spectral spread, the spectral roll-off, the spectral skewness, the root mean square (RMS) band energy (or the normalized sub-band energies/band energy ratios), a loudness or total RMS energy, a spectral flatness, a spectral slope, a spectral kurtosis, a spectral flux, a spectral autocorrelation function, or a normalized variant thereof.

The spectral centroid denotes the “brightness” of the sound captured by the optical fiber (e.g., optical fiber 162 shown in FIG. 1) and indicates the center of gravity of the frequency spectrum in the acoustic sample. The spectral centroid can be calculated as the weighted mean of the frequencies present in the signal, where the magnitudes of the frequencies present can be used as their weights in some embodiments.

The spectral spread is a measure of the shape of the spectrum and helps measure how the spectrum is distributed around the spectral centroid. In order to compute the spectral spread, Sᵢ, one has to take the deviation of the spectrum from the computed centroid as per the following equation (all other terms defined above):

$${S}_{i} = \sqrt{\frac{{\sum }_{k = 1}^{N} {( f ( k ) - {C}_{i} )}^{2} {X}_{i} ( k )}{{\sum }_{k = 1}^{N} {X}_{i} ( k )}} . \qquad ( Eq . 2 )$$

The spectral roll-off is a measure of the bandwidth of the audio signal. The Spectral roll-off of the i^{th} frame, is defined as the frequency bin ‘y’ below which the accumulated magnitudes of the short-time Fourier transform reach a certain percentage value (usually between 85%-95%) of the overall sum of magnitudes of the spectrum.

$${\sum }_{k = 1}^{y} \vert {X}_{i} ( k ) \vert = \frac{c}{100} {\sum }_{k = 1}^{N} \vert {X}_{i} ( k ) \vert , \qquad ( Eq . 3 )$$

where c=85 or 95. The result of the spectral roll-off calculation is a bin index and enables distinguishing acoustic events based on dominant energy contributions in the frequency domain (e.g., between gas influx and liquid flow, etc.).

The spectral skewness measures the symmetry of the distribution of the spectral magnitude values around their arithmetic mean.

The RMS band energy provides a measure of the signal energy within defined frequency bins that may then be used for signal amplitude population. The selection of the bandwidths can be based on the characteristics of the captured acoustic signal. In some embodiments, a sub-band energy ratio representing the ratio of the upper frequency in the selected band to the lower frequency in the selected band can range between about 1.5:1 to about 3:1. In some embodiments, the sub-band energy ratio can range from about 2.5:1 to about 1.8:1, or alternatively be about 2:1 The total RMS energy of the acoustic waveform calculated in the time domain can indicate the loudness of the acoustic signal. In some embodiments, the total RMS energy can also be extracted from the temporal domain after filtering the signal for noise.

The spectral flatness is a measure of the noisiness/tonality of an acoustic spectrum. It can be computed by the ratio of the geometric mean to the arithmetic mean of the energy spectrum value and may be used as an alternative approach to detect broad-banded signals. For tonal signals, the spectral flatness can be close to 0 and for broader band signals it can be closer to 1.

The spectral slope provides a basic approximation of the spectrum shape by a linearly regressed line. The spectral slope represents the decrease of the spectral amplitudes from low to high frequencies (e.g., a spectral tilt). The slope, the y-intersection, and the max and media regression error may be used as features.

The spectral kurtosis provides a measure of the flatness of a distribution around the mean value.

The spectral flux is a measure of instantaneous changes in the magnitude of a spectrum. It provides a measure of the frame-to-frame squared difference of the spectral magnitude vector summed across all frequencies or a selected portion of the spectrum. Signals with slowly varying (or nearly constant) spectral properties (e.g., noise) have a low spectral flux, while signals with abrupt spectral changes have a high spectral flux. The spectral flux can allow for a direct measure of the local spectral rate of change and consequently serves as an event detection scheme that could be used to pick up the onset of acoustic events that may then be further analyzed using the feature set above to identify and uniquely classify the acoustic signal.

The spectral autocorrelation function provides a method in which the signal is shifted, and for each signal shift (lag) the correlation or the resemblance of the shifted signal with the original one is computed. This enables computation of the fundamental period by choosing the lag, for which the signal best resembles itself, for example, where the autocorrelation is maximized. This can be useful in exploratory signature analysis/even for anomaly detection for well integrity monitoring across specific depths where well barrier elements to be monitored are positioned.

Any of these frequency domain features, or any combination of these frequency domain features (including transformations of any of the frequency domain features and combinations thereof), can be used to determine the location, type, and flow rate of fluid inflow or the fluid inflow discrimination as described hereinbelow. In an embodiment, a selected set of characteristics can be used to identify the presence or absence for each fluid inflow event, and/or all of the frequency domain features that are calculated can be used as a group in characterizing the presence or absence of a fluid inflow event. The specific values for the frequency domain features that are calculated can vary depending on the specific attributes of the acoustic signal acquisition system, such that the absolute value of each frequency domain feature can change between systems. In some embodiments, the frequency domain features can be calculated for each event based on the system being used to capture the acoustic signal and/or the differences between systems can be taken into account in determining the frequency domain feature values for each fluid inflow event between or among the systems used to determine the values and the systems used to capture the acoustic signal being evaluated.

One or a plurality of frequency domain features can be used to characterize each type of event (e.g., fluid inflow, water inflow, gas inflow, hydrocarbon liquid inflow) and/or to classify the flow rate of each identified type of fluid flow/inflow (e.g., water, gas, hydrocarbon liquid, etc.). In an embodiment, one, or at least two, three, four, five, six, seven, eight, etc. different frequency domain features can be used to characterize each type of event and/or to classify the flow rate of each identified type of fluid flow/inflow. The frequency domain features can be combined or transformed in order to define the event signatures for one or more events. While exemplary numerical ranges are provided herein, the actual numerical results may vary depending on the data acquisition system and/or the values can be normalized or otherwise processed to provide different results.

Referring still to FIG. 1, as previously described in some embodiments method 10 may also comprise normalizing the one or the plurality of frequency domain features at 400 and then identifying the one or more fluid inflow locations at 500 and/or prior to identifying the at least one of the gas phase inflow, the aqueous phase inflow, or the hydrocarbon liquid phase inflow at 600. As shown in FIG. 1, in some embodiments, method 10 may proceed to identifying the one or more fluid inflow locations at 500 without first normalizing the frequency domain features at 400. The one or more fluid inflow locations at 500 may be determined via other data, knowledge or experience as known to those of having ordinary skill. For instance, in some embodiments, the one or more fluid inflow locations may be determined via PLS data at 500. In some embodiments, the one or more fluid inflow locations at 500 are determined as described hereinbelow.

For example, in some embodiments, block 500 may comprise identifying the one or more fluid flow and/or inflow locations using one or more of the frequency domain features to identify acoustic signals corresponding to the flow and/or inflow, and correlating the depths of those signals with locations within the wellbore. The one or more frequency domain features can comprise at least two different frequency domain features in some embodiments. In some embodiments, the one or more frequency domain features utilized to determine the one or more fluid inflow locations comprises at least one of a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, as well as combinations, transformations, and/or normalized variant(s) thereof.

In some embodiments, block 500 of method 10 may comprise: identifying a background fluid flow signature using the acoustic signal; and removing the background fluid flow signature from the acoustic signal prior to identifying the one or more fluid inflow locations. In some embodiments, identifying the one or more fluid inflow locations comprises identifying one or more anomalies in the acoustic signal using the one or more frequency domain features of the plurality of frequency domain features; and selecting the depth intervals of the one or more anomalies as the one or more inflow locations, When a portion of the signal is removed (e.g., a background fluid flow signature, etc.), the removed portion can also be used as part of the event analysis. Thus, in some embodiments, identifying the one or more fluid inflow locations at block 500 comprises: identifying a background fluid flow signature using the acoustic signal; and using the background fluid flow signature from the acoustic signal to identify as event such as one or more fluid flow events.

Referring still to FIG. 1, in some embodiments, method 10 comprises identifying at least one of a gas phase inflow, an aqueous phase inflow, or a hydrocarbon liquid phase inflow using a plurality of frequency domain features at the identified one or more fluid inflow locations at 600. In some embodiments, method 10 may progress to block 600 immediately following block 300 or following blocks 400 and/or 500 as previously described above and shown in FIG. 1. In some embodiments, the plurality of frequency domain features utilized at block 600 may comprise one more of the frequency domain features described herein including combinations, variants (e.g., a normalized variant), and/or transformations thereof. For instance, in some embodiments, at least two such frequency domain features (and/or combinations, variants, or transformations thereof) are utilized at block 600. In some embodiments, the frequency domain features utilized within block 600 may comprise a ratio between at least two of the plurality of the frequency domain features. Specifically, in some embodiments, the frequency domain features utilized at 600 may comprise a normalized variant of the spectral spread and/or a normalized variant of the spectral centroid.

Referring still to FIG. 1, in some embodiments, block 600 of method 10 may comprise providing the plurality of frequency domain features to a fluid flow model (e.g., a logistic regression model) at 600′ for each of the gas phase, the aqueous phase, and the hydrocarbon liquid phase; and determining that at least one of the gas phase, the aqueous phase, or the hydrocarbon liquid phase is present based on the fluid flow model. In some embodiments, the fluid flow model can be developed using and/or may include machine learning such as a neural network, a Bayesian network, a decision tree, a logistical regression model, or a normalized logistical regression, or other supervised learning models. In some embodiments, the model at 600′ may define a relationship between at least two of the plurality of the frequency domain features, including in some embodiments combinations, variations, and/or transformations of the frequency domain features and one or more fluid flows. In some embodiments, block 600′ may comprise utilizing a plurality of different models to identify each type flow/inflow (e.g., gas, aqueous, hydrocarbon liquid, etc.). For instance, block 600 may comprise utilizing a first model to identify a gas phase inflow/flow, a second model to identify an aqueous phase inflow/flow, and a third model to identify a hydrocarbon liquid phase inflow/flow. In some embodiments, one or more (e.g., all) of the first, second, and third models may comprise multivariable models. In some of these embodiments, the first, second, and third models may utilize one or more (e.g., at least two) of the frequency domain features (which may or may not be the same for each of the first, second, and third models) as inputs therein.

In some embodiments, block 600 (e.g., such as block 600′) may comprise utilizing the plurality of frequency domain features at the identified one or more fluid inflow locations in the model(s) (e.g., the first, second, third model as described above) and then comparing the plurality of frequency domain features to an output of the model(s); and identifying at least one of the gas phase inflow, the aqueous phase inflow, or the hydrocarbon liquid phase inflow based on the comparison(s).

Referring still to FIG. 1, method 10 may further comprise classifying amounts of gas phase inflow, aqueous phase inflow, and hydrocarbon liquid phase inflow at 700. In particular, as previously described above classifying the amounts of the types of fluid flow/inflow (e.g., gas, aqueous, hydrocarbon liquid, etc.) may comprise classifying the flow rate (e.g., in volume per unit time—such as barrels per day) of each identified fluid inflow/flow type into one of a plurality of predefined flow rate ranges. The predefined flow rate ranges can be determined for each type of flow corresponding to the flow model. For example, a first set of predefined flow rate ranges can be determined for gas flow/inflow, a second set of predefined flow rate ranges can be determined for aqueous flow/inflow, and a third set of predefined flow rate ranges can be determined for hydrocarbon liquid flow/inflow. These various predefined flow rate ranges can then be used with a labeled data set (e.g., frequency domain features sets with known, or labeled, inflow or flow rate that can be derived from test data, known historical data, etc.) to determine models for each of the flow rate ranges and fluid types.

In some embodiments, the plurality of predefined ranges may comprise a plurality of pre-defined ranges corresponding with low, medium, and high flow rates for each of the identified fluid flows/inflows. However, in other embodiments, the plurality of pre-defined ranges may correspond with other flow rates (i.e., other than low, medium, and high). In some embodiments, the predefined flow rate ranges may be selected to indicate (e.g., to personnel monitoring production from the well) whether certain production conditions or parameters are being met. In some embodiments, the predefined flow rate ranges may be selected so as to indicate (again to suitable personnel or other machine implemented monitoring applications) that desired and/or problematic production conditions (e.g., with respect to production amounts of the identified fluids) are present. Thus, in some embodiments, the predefined flow rate ranges may have different magnitudes, scopes, boundaries, etc. In some embodiments, at least some of the predefined flow rate ranges may have an equal scope or magnitude. In some embodiments, the predefined flow rate ranges may not include a zero-flow condition such that the predefined flow rate ranges may include and be bounded by values that are greater than zero. The size, scope, magnitude, and number of predefined flow rate ranges may be selected and varied in some embodiments due to the specific parameters of the wellbore in question (e.g., wellbore 114 in FIG. 2), and/or the desired flow rate conditions that are being monitored for the wellbore in question.

The flow rate models can be developed using and/or may include machine learning such as a neural network, a Bayesian network, a decision tree, a logistical regression model, or a normalized logistical regression, or other supervised learning models with known labeled data sets. In some embodiments, the flow rate models may each define a relationship between at least two of the plurality of the frequency domain features, including in some embodiments combinations, variations, and/or transformations of the frequency domain features and a flow rate for a specific fluid type. A plurality of models can then be developed for each fluid type that corresponds to each flow rate range in the predefined flow rate ranges for that fluid type. The flow rate models may each utilize one or more (e.g., at least two) of the frequency domain features as inputs, which may or may not be the same for each of the models within a fluid type or for the models across different fluid flow types.

In some embodiments, block 700 may comprise using one more (e.g., a plurality of) the frequency domain features described above to classify the flow rate of the fluids flows/inflows identified at block 600. Specifically, in some embodiments, one or more of the flow rate models, utilizing one or more frequency domain features as inputs, may be used at block 700 to classify the flow rate of each identified fluid flow/inflow into the predefined ranges. For instance, as is similarly described above for block 600 (including block 600′), block 700 may comprise utilizing a separate, different model (or a plurality of separate models) for classifying the flow rate of each identified fluid flow/inflow. Thus, a first flow rate model (or a plurality of first flow rate models) may be used to classify the flow rate of an identified gas flow/inflow, a second flow rate model (or a plurality of second flow rate models) may be utilized to classify the flow rate of an identified aqueous flow/inflow, and a third flow rate model (or a plurality of third flow rate models) may be utilized to classify the flow rate of an identified hydrocarbon flow/inflow. Each of the first, second, and third flow rate models at block 700 may use one or more, such as at least two (or a plurality of) the above described frequency domain features (including as previously described, combinations, transformations, and/or variants thereof) as inputs. The frequency domain features used in each of the first, second, and third models at block 700 may be the same or different. Additionally, as will be described in more detail below, the flow rate model(s) used to classify the fluid flow rate(s) at block 700 may be derived via machine learning, such as, for instance a supervised machine learning process whereby known experiment data is utilized to construct and/or refine the model(s).

In addition, in some embodiments, each of the first, second, and third flow rate models described above may include a plurality of flow rate models—each to determine whether the flow rate of the particular fluid in question falls within a plurality of predetermined flow rate ranges. Thus, the first flow rate model may comprise a plurality of first flow rate models where each of the first flow rate models may determine whether the flow rate of the gas flow/inflow is within a corresponding one of the plurality of predefined flow rate ranges, based on a selected plurality of frequency domain features (which may be the same or different for the plurality of first models). Likewise, the same may be true for the second and third flow rate models, such that the second flow rate model and third flow rate model may comprise a plurality of second flow rate models and a plurality of third flow rate models, respectively, for determining whether the flow rate of the aqueous flow/inflow and hydrocarbon liquid flow/inflow, respectively, fall within a plurality of predetermined flow rate ranges.

In some embodiments, the flow rate model(s) used to classify the flow rates of the identified fluid flows/inflows at block 700 may define decision boundaries using two or more frequency domain features. Each decision boundary may determine whether a type of identified fluid flow/inflow (e.g., gas, aqueous, hydrocarbon liquid, etc.) has a flow rate that is within a particular flow rate range. Thus, in embodiments where there are two flow rate ranges for each identified fluid flow/inflow, the flow rate model(s) may construct two decision boundaries for each identified fluid flow/inflow—one for determining whether a particular type of fluid has a flow rate in a first flow rate range, and a second for determining the particular type of fluid has a flow rate in a second flow rate range, where the first flow rate range is different from the second flow rate range (e.g., higher, lower, etc.).

Each decision boundary may be based on two or more selected frequency domain features. For instance, in some embodiments a flow rate model utilized at block 700 may mathematically define a decision boundary as a line in two dimensional space where the axes of the two dimensional space are defined by two selected frequency domain features. In other embodiments, a flow rate model utilized at block 700 may construct or define a decision boundary as a three-dimensional surface where the axes of the three dimensional space are defined by three selected frequency domain features. Regardless of the number of frequency domain features utilized by the models at block 700, when points are plotted in the dimensional space defined by the selected frequency domain features (e.g., a 2, 3, 4, 5, . . . N dimensional space determined by the number of selected frequency domain features), the position of plotted points in the dimensional space (e.g., plotted points of the selected frequency domain features) with respect to the decision boundary may determine whether a type of fluid does or does not have a flow rate within a particular flow rate range. The frequency domain features selected to construct the decision boundaries associated with the predetermined flow rate ranges for a particular type of identified fluid may be the same or different. In some embodiments, one or more of the axes of the dimensional space containing a particular decision boundary may comprise a combination, variation, and/or transformation of a frequency domain feature as previously described above.

The classification at block 700 of the flow rates for the flow/inflow of the fluids identified at block 600 may be carried out for flow rates over a predetermined period of time (e.g., a period of second, minutes, hours, days, weeks, months, etc.). The predetermined period of time may comprise the entire producing life of the well (e.g., such as wellbore 114 in FIG. 2) or some period that is less than the entire working life of the well. Specifically, the period of time associated with the acoustic signal at block 100, and thus the period of time associated with the selected frequency domain features from block 300 may define the period of time over which the flow rates of the identified fluid types may be classified at block 700.

In some embodiments, for a given time period the classified flow rate of a given fluid (e.g., gas, aqueous, hydrocarbon liquid) may fluctuate between multiple predetermined flow rate ranges. In these embodiments, the model(s) may present a dominant flow rate range as the flow rate for the given fluid over the designated period of time. As used herein, the dominant flow rate range over a given period of time may represent the flow rate range that the given fluid most often was classified into during the given period of time. As one specific example, a given fluid may be classified into a first flow rate range for a first portion of a given period of time, and is classified into a second flow rate range for a second portion of the given period of time. If the first portion is greater than the second portion, the first flow rate range may be determined to be the dominant flow rate range over the entire given period of time.

In addition, the classification at block 700 of the flow rates for the flow/inflow of the fluids identified at block 600 may be carried out for flow rates over an entire depth of a wellbore (e.g., wellbore 114 in FIG. 2) or at one or more discrete depths or depth ranges within the wellbore. Specifically, the classification at block 700 may classify different flow rates at different depths (or depth ranges) within a wellbore by analyzing the frequency domain features (e.g., within the one or models as described above) associated with the different depths (or depth ranges). Accordingly, via the classification at block 700, one may determine an overall flow rate range for a particular fluid type (e.g., gas, aqueous, hydrocarbon liquid, etc.) over an entire depth of a given wellbore, and/or may classify flow rates for a particular fluid type at a plurality of different depths (or depth ranges) within the given wellbore.

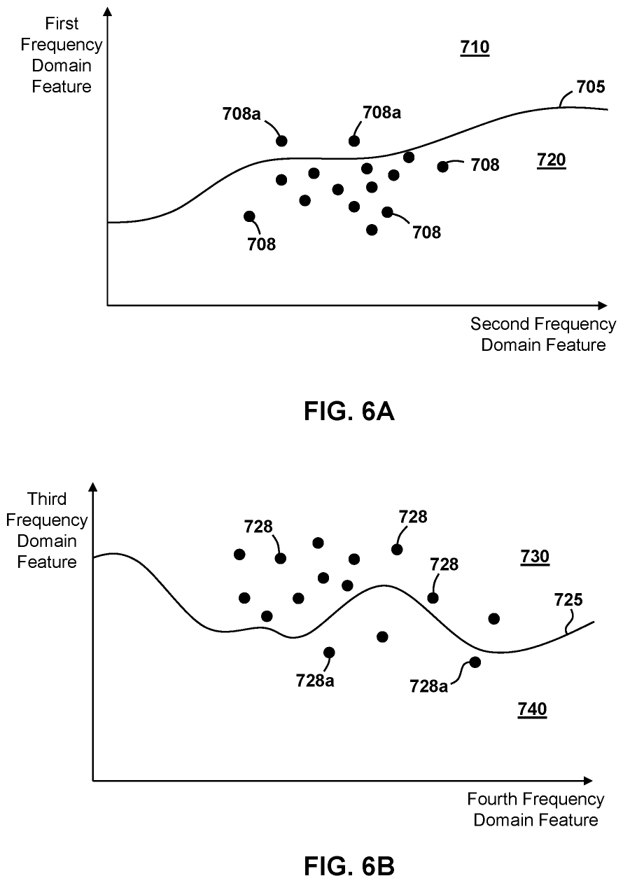

Referring now to FIGS. 6A and 6B, in order to further illuminate some embodiments of the fluid flow rate classification at block 700, a particular example is described below. However, it should be appreciated that the particular example described below is not intended to limit all other potential embodiments described herein. In particular, FIGS. 6A and 6B show two example plots of selected frequency domain features that may be used at block 700 of method 10 (see e.g., FIG. 1) for classifying the flow rate of the flow/inflow for a particular identified fluid (e.g., gas, aqueous, hydrocarbon liquid, etc.) Additional plots similar to those shown in FIGS. 6A and 6B may be defined to classify the flow rates of other identified fluids (e,g., such as fluid types identified at block 600 in method 10 of FIG. 1).

FIG. 6A shows a first plot for determining whether a flow rate of the identified fluid is classified into a first flow rate range, and FIG. 6B shows a second plot for determining whether the flow rate of the identified fluid is classified into a second flow rate range that is different from the first flow rate range. In this embodiment, the first flow rate range associated with the plot in FIG. 6A is a so-called low flow rate range (e.g., <750 barrels per day in one particular example), and the second flow rate range associated with the plot in FIG. 6B is a so-called high flow rate range (e.g., >750 barrels per day in one particular example). Thus, the first flow rate is lower than the second flow rate.

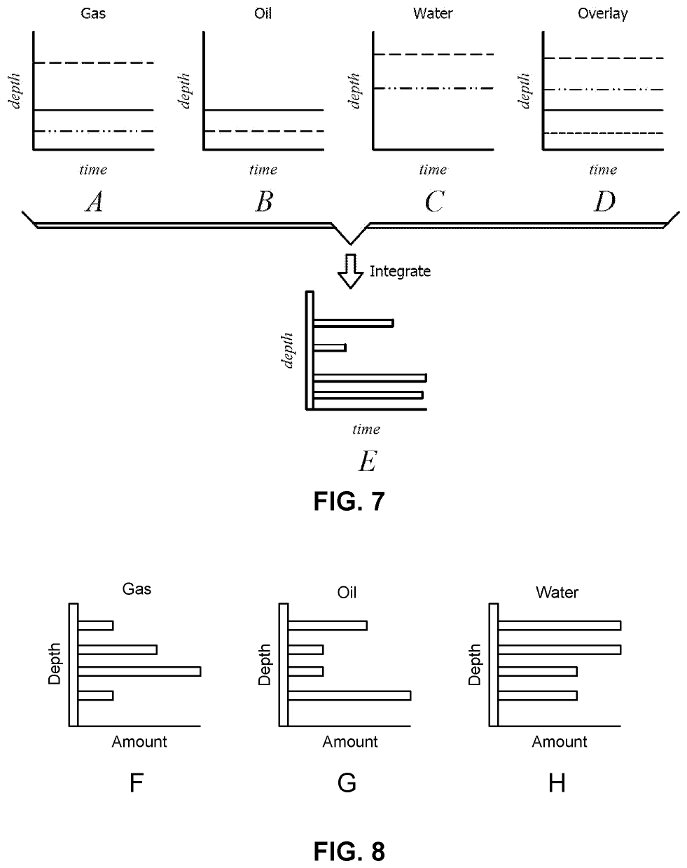

The plots of FIGS. 6A and 6B are two dimensional plots, and thus, each includes two axes, with each axis being associated with one of the selected frequency domain features (or a single combination of two or more frequency domain features, or a variant or transformation of a selected frequency domain feature or a combination of frequency domain features). In particular, the plot of FIG. 6A is a two dimensional space defined by axes of a first frequency domain feature and a second frequency domain feature, and the plot of FIG. 7B is a two dimensional spaced defined by axes of a third frequency domain feature and a third frequency domain feature. The first frequency domain feature is different from the second frequency domain feature. Similarly, the third frequency domain feature is different from the fourth frequency domain feature. The first and second frequency domain features may be the same or different from the third and fourth frequency domain features, respectively.

However, as previously described above, in some embodiments, the plots of FIGS, 6A and 6B may include three or more dimensions, wherein additional axes are defined by still more selected frequency domain features (or combinations, transformation, and/or variant thereof as previously described). Without being limited to this or any other theory, the inclusion of additional axes (and thus dimensions) within the plots of FIGS. 6A and 6B may provide enhanced accuracy to the ultimate classification determinations for the flow rate of the fluid in question, but also include additional computations and variables.

The plot of FIG. 6A includes a first decision boundary 705, and the plot of FIG. 6B includes a second decision boundary 725. The first decision boundary 705 may define and separate a first side 710 from a second, opposite side 720 within the plot of FIG. 6A and the second decision boundary 725 may define and separate a first side 730 from a second, opposite side 740 within the plot of FIG. 6B. Within the plot of FIG. 6A, the first side 710 may be associated with flow rates that are within the first flow rate range, and the second side 720 may be associated with flow rates that are not within the first flow rate range. Similarly, within the plot of FIG. 6B, the first side 730 may be associated with flow rates that are within the second flow rate range, and the second side 740 may be associated with flow rates that are not within the second flow rate range.

During operations, points 708 of the first frequency domain feature vs the second frequency domain feature are plotted on the plot of FIG. 6A, and points 728 of the third frequency domain feature vs the fourth frequency domain feature are plotted on the plot of FIG. 6B. The points 708 in FIG. 6A may be disposed (or predominantly disposed) on the second side 720 of the first decision boundary 705, thereby indicating that the flow rate of the given fluid is not within the first flow rate range. Conversely, the points 728 in FIG. 6B may be disposed (or predominantly disposed) on the first side 730 of the second decision boundary 725, thereby indicating that the flow rate of the given fluid is within the second flow rate range. Thus, taken together, the plots of FIGS. 6A and 6B may indicate that the flow rate of the given fluid is within the second flow rate range.

As shown in FIGS. 6A and 6B, some of the points 708 (identified as points 708a) are disposed on the second side 720 of first decision boundary 705, and some of the points 728 (identified as points 728a) are disposed on the first side 730 of second decision boundary 725. However, points 708a are considered outliers within the plot of FIG. 6A since a majority of the points 708 are disposed on the second side 720 of first decision boundary 705 (i.e., the presence of the minority of points on the first side 710 does not alter the determination that the flow rate of the particular fluid is not within the first flow rate range). Similarly, points 728a are considered outliers within the plot of FIG. 6B since a majority of the points 728 are on the first side 730 of the second decision boundary 725 (i.e., the presence of the minority of points on the second side 740 does not alter the determination that the flow rate of the particular fluid is within the second flow rate range).

In some embodiments, a probability may be calculated for each flow rate range for a given set or series of points (e.g., points 708, 728, etc.). Specifically, if there are points on either side of the decision boundary (e.g., such as shown for points 708, 708a in FIG. 6A and points 728, 728a in FIG. 6B), a probability may be assigned to the determined flow rate range, which may be determined by considering the number of data points on the sides 710, 720 and 730, 740 of the decision boundaries 705, 725, respectively. Thus, as the relative fraction or percentage of points (e.g., points 708, 728, etc.) are on a given side of a decision boundary, the probability of the determination indicated by the plot in question may increase. Accordingly, if the data indicates that the flow rate may be within more than one of the predefined flow rate ranges, the flow rate range with the highest probability may be selected as the final determined flow rate range for the data.

It should be appreciated that the plots of FIGS. 6A and 6B may represent frequency domain features for acoustic data over a given period of time and/or for acoustic data at desired depths. Thus, the plots of FIGS. 6A and 6B may indicate the flow rate range of a particular fluid over the given time period and at the desired depth (or depth range). The flow rate range of the particular fluid may comprise a dominant and/or average flow rate range for the particular fluid over the given time period and depth(s). Thus, in some embodiments, a plurality of plots similar to those described above for FIGS. 6A and 6B may be utilized to classify the flow rate for a particular fluid over multiple depths or depth ranges and over multiple periods of time.

In some embodiments, the flow rate model(s) may be regression models that correlate a plurality of frequency domain features with a predicted flow rate. In this embodiment, the flow rate model(s) can use labeled data to develop a prediction model that can accept the plurality of frequency domain features and predict a flow rate value. The model can have a certain error rate based on the amount of data used in the regression analysis of the labeled data. The prediction model can be used for a given fluid type over a wide range of flow rate values (as opposed to flow rate ranges), or the predictive model can be developed over smaller ranges (e.g., within flow rate ranges). As a result, a predictive model may be developed for each of the fluid flow types, and one or more models can be developed within each fluid flow type. Once developed, the detected plurality of frequency domain features can be used with the predictive model to determine a fluid flow rate value or amount directly from the model. The predictive model can be used in addition to or in place of the flow rate models.

Referring again to FIG. 1, method 10 may also include determining and/or performing a remediation procedure at 800. The remediation procedure determined and/or performed can be based on the amounts (e.g., flow rates) of the gas phase inflow, the aqueous phase inflow, or the hydrocarbon liquid phase inflow that were classified at 700, the confidence level determined at 650, or a combination thereof. In addition, the remediation steps/procedure may comprise any of the steps or actions described herein that may be taken in response to fluid flow/inflow characterization data (e.g., isolating production zones, opening/closing/choking production assemblies at various levels, drilling or isolating side wells, etc.).

In some embodiments, method 10 may additionally include displaying one or more graphics that represent the presence, type, and flow rate classification of the different fluid flow/inflows within the wellbore (e.g., wellbore 114 shown in FIG. 2). For instance, for the DAS system 110 of FIG. 2, the machine-readable instructions executing on the processor 168 can be used to visualize the fluid inflow type (e.g., such as from block 600 in method 10) locations (e.g., such as from block 500 in method 10) or classified amounts (e.g., such as from block 700 in method 10) over a computer network for visualization on a remote location.

For example, as depicted in FIG. 7, an output can comprise plots of the gas phase inflow, the hydrocarbon liquid phase inflow, and aqueous phase inflow as a function of depth in the well and time as depicted in panels A, B, and C, respectively. The plots (e.g., the plots of panels A, B, and C) can be overlaid to provide a single plot depicting the gas phase inflow, aqueous phase inflow, and hydrocarbon liquid phase inflow as a function of depth in the well and time, as depicted in panel D of FIG. 7. Alternatively or additionally, the data can be integrated to provide a cumulative display of the amounts of gas phase inflow, aqueous phase inflow, and hydrocarbon liquid phase inflow as a function of depth in the well and time, as depicted in panel E of FIG. 7.

As another example, reference is now made to FIG. 8, in some embodiments, an output can comprise plots of the classified amounts (e.g., flow rates) of the gas inflow/flow, hydrocarbon liquid inflow/flow, and aqueous inflow/flow as a function of depth as depicted in panels F, G, and H, respectively. The depicted amounts may be displayed for a predetermined time period. In some embodiments, multiple plots such as those shown in panels F, G, and H of FIG. 8 may be output to show the amounts (e.g., flow rates) of the gas, hydrocarbon liquid, and aqueous inflow/flow as a function of depth for discrete portions of an overall time period (e.g., such as an hourly report over a day or month showing how the flow rates of the different fluid types change over time). In some embodiments, the output may include plots such as those shown in panels F, G, and H that represent a running average of the respective flow rate amounts over a total time as time and data accumulate,

The computation of a fluid inflow event log (which may include inflow type, location, and/or amount as previously described) may be done repeatedly, such as every second, and later integrated/averaged for discrete time periods—for instance, at times of higher well drawdowns, to display a time-lapsed event log at various stages of the production process (e.g., from baseline shut-in, from during well ramp-up, from steady production, from high drawdown/production rates etc.). The time intervals may be long enough to provide suitable data, though longer times may result in larger data sets. In an embodiment, the time integration may occur over a time period between about 0.1 seconds to about 10 seconds, or between about 0.5 seconds and about a few minutes or even hours, days, weeks, months, years, etc.

The resulting fluid inflow event log(s) computed every second can be stored in a memory (e.g., such as memory 170 shown in FIG. 2 and discussed above) or transferred across a computer network, to populate a fluid inflow event database. The data can be used to generate an integrated fluid inflow event log at each fluid inflow event depth sample point along the length of a optical fiber (e.g., optical 162 shown in FIG. 2) along with a synchronized timestamp that indicates the times of measurement. In producing a visualization fluid inflow event log, the values for depth sections that do not exhibit fluid inflow can be set to zero. This allows those depth points or zones exhibiting fluid inflow to be easily identified,

If water or gas inflow is observed in the produced fluid (as determined by methods such as surface detectors, visual observation, etc.), but the location and/or amount of the water or gas inflow cannot be identified with sufficient clarity using the methods described herein, various actions can be taken in order to obtain a better visualization of the acoustic data. For example, in some embodiment, the production rate can be temporarily increased. The resulting data analysis can be performed on the data during the increased production period. In general, an increased fluid flow rate into the wellbore may be expected to increase the acoustic signal intensity at the fluid inflow locations. This may allow a signal to noise ratio to be improved in order to more clearly identify fluid flow and/or inflow at one or more locations by, for example, providing for an increased signal strength. The water, gas, and/or hydrocarbon liquid flow and/or inflow energies can also be more clearly calculated based on the increased signal outputs. Once the zones of interest are identified, the production levels can be adjusted based on the water or gas inflow locations and amounts. Any changes in water and/or gas production amounts over time can be monitored using the techniques described herein and the operating conditions can be adjusted accordingly (e.g., dynamically adjusted, automatically adjusted, manually adjusted, etc.).

In some embodiments, the change in the production rate can be used to determine a production rate correlation with the fluid inflow locations and flow rates at one or more points along the wellbore. In general, decreasing the production rate may be expected to reduce the fluid inflow rates and fluid flow rates. By determining production rate correlations with the fluid inflow rates, the production rate from the well and/or one or more zones can be adjusted to reduce the fluid inflow rate at the identified locations. For example, an adjustable production sleeve or choke can be altered to adjust specific fluid inflow rates in one or more production zones. If none of the production zones are adjustable, various workover procedures can be used to alter the production from specific zones. For example, various intake sleeves can be blocked off, zonal isolation devices can be used to block off production from certain zones, and/or some other operations can be carried out to reduce the amount of undesired fluid inflow (e.g., consolidation procedures, etc.).

The same analysis procedure can be used with any of the fluid flow and/or inflow event signatures described herein. For example, the presence of one or more fluid inflow events (e.g., fluid inflow, gas inflow, water inflow, hydrocarbon liquid inflow) can be determined. In some embodiments, the location and or discrimination between events may not be clear. One or more characteristics of the wellbore can then be changed to allow a second measurement of the acoustic signal to occur. For example, the production rate can be changed, the pressures can be changed, one or more zones can be shut-in, or any other suitable production change. For example, the production rate can be temporarily increased, which may allow additional data to be collected as previously described above.

Referring again to FIG. 1, in some embodiments method 10 may not actively identify the one or more of a gas phase flow, aqueous phase flow, or hydrocarbon liquid phase flow at 600 or fluid flow/inflow locations at 500 prior to classifying the amounts of these flows at 700. Rather, in some embodiments, method 10 may classify the flow rates of the one or more fluid types using the frequency domain features and being based on known fluid types and/or locations. For instance, in some embodiments, the fluid flow locations and/or types may be determined via methods other than those discussed above for blocks 500, 600, and then this information may be utilized within block 700 in the same manner described above to classify the flow rates of these known/identified fluid types.

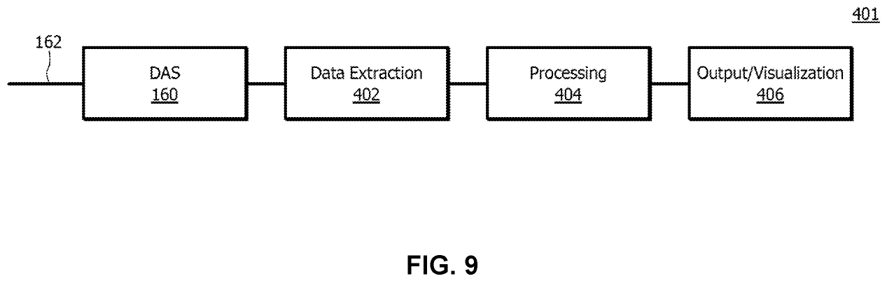

As shown schematically in FIG. 9, an embodiment of a system 401 for detecting the presence, type, and flow rate of fluid inflow in the manner described above for method 10 is shown. System 401 may comprise a data extraction unit 402, a processing unit 404, and/or an output or visualization unit 406. One or more of the data extraction unit 402, processing unit 404, and/or output or visualization unit 406 may be housed or integrated within a controller (or collection of controllers) for carrying out some or all of the functions described herein (e.g., the features of method 10). The data extraction unit 402 can obtain the optical data and perform the initial pre-processing steps to obtain the initial acoustic information from the signal returned from the wellbore (such as is described above for blocks 100 and 200 of method 10 in FIG. 1). Various analyses can be performed including frequency band extraction, frequency analysis and/or transformation, intensity and/or energy calculations, and/or determination of one or more properties of the acoustic data. Following the data extraction unit 402, the resulting signals can be sent to a processing unit 404. Within the processing unit, the acoustic data can be analyzed, for example, by calculating one or more frequency domain features and utilizing a model or models, which can be obtained from a machine learning approach (e.g., a supervised learning approach, etc.), on the one or more frequency domain features as previously described to determine if fluid flow and/or inflow is present, and, if present, determining if the fluid flow and/or inflow comprises water flow and/or inflow, hydrocarbon liquid flow and/or inflow, and/or gas flow and/or inflow, and classifying a flow rate of each identified fluid flow and/or inflow (such as is described above for blocks 300-700 in method 10 of FIG. 1).

One or more models can also be used to determine the presence of various fluid flow regimes within a conduit within the wellbore. In some embodiments, the machine learning approach comprises a logistic regression model. In some such embodiments, a single frequency domain feature (e.g., spectral flatness, RMS bin values, etc.) can be used to determine if fluid inflow is present at each location of interest. In some embodiments, the supervised learning approach can be used to determine a model of the various flow regimes such as a first polynomial having the plurality of frequency domain features as inputs to determine when gas phase inflow is present, a second polynomial having the plurality of frequency domain features as inputs to determine when aqueous phase inflow is present, and a third polynomial having the plurality of frequency domain features as inputs to determine when hydrocarbon liquid phase inflow is present.

In addition, the processing unit 404 may also apply a classification algorithm to determine which of a plurality of predetermined flow rate ranges to apply to each of the identified inflow or flow (such as is described above for block 700 of method 10 in FIG. 1). As previously described, the classification algorithm may utilize one or more of the frequency domain features (e.g., a plurality of frequency domain features) to determine which flow rate of the plurality of predetermined flow rate ranges applies to the identified inflow or flow.

Once the processing unit 404 uses the models obtained from the machine learning approach to determine the presence or lack of fluid inflow (e.g., gas inflow, water inflow, hydrocarbon liquid inflow, etc.) and the composition (e.g., gas, hydrocarbon liquid, water) and flow rate thereof, the resulting analysis information can then be sent from the processing unit 404 to the output/visualization unit 406 where various information such a visualization of the location of the inflow and/or information providing quantification information (e.g., a flow rate classification of the gas inflow, water inflow, hydrocarbon liquid inflow, and the like) can be visualized in a number of ways (such as that previously described above with reference to FIGS. 7 and 8). In an embodiment, the resulting event information can be visualized on a well schematic, on a time log, or any other number of displays to aid in understanding where the inflow is occurring, and in some embodiments, to display a relative amount of the various components of the inflowing fluid occurring at one or more locations along the length of the wellbore. While illustrated in FIG. 9 as separate units, any two or more of the units shown in FIG. 9 can be incorporated into a single unit. For example, a single unit can be present at the wellsite to provide analysis, output, and optionally, visualization of the resulting information.

Other multivariate models can also be developed using the processes described herein. For instance, as will be described in more detail below, in some embodiments, labelled data sets including test data can be generated for an expected event within a wellbore using a flow loop or flow test apparatus as disclosed herein. The desired event or flow can be created, and the test data can be captured. The resulting labeled (or known) data sets can be used to train the one or more models (e.g., the models used at blocks 600, 700, etc.) to determine the presence of the event using one or more frequency domain features. As an example of an additional multivariate model, sand inflow and/or flow in a fluid phase within a conduit can be modeled. The sand flow can be modeled in different fluid phases, at different sand amounts, in different orientations, and through different types of production assemblies, pipes, annuli, and the like. The resulting acoustic data can be used in the model development process as disclosed herein to determine one or more multivariate models indicative of the presence of sand in an inflowing fluid in one or more fluid phases and/or in a flowing fluid within the wellbore within one or more fluid phases. Such multivariate model may then be used with detected acoustic data to determine if sand is present in various fluids while allowing for discrimination between sand inflow and/or sand flow along the wellbore.

In some embodiments, the model(s) at 600′ and the model(s) at block 700 of method 10 can be developed using machine learning. In order to develop and validate the model, data having known fluid flows (including fluid type, flow rate, and inflow location) and acoustic signals can be used as the basis for training and/or developing the model parameters. This data set can be referred to as a labeled data set (e.g., a data set for which the flow regime and/or inflow location is already known) that can be used for training the models in some instances. In some embodiments, the known data can be data from a wellbore having flow characteristics measured by various methods. In some embodiments, the data can be obtained using a test setup where known quantities of various fluids (e.g., gas, hydrocarbon liquids, aqueous liquids, etc.) can be introduced at one or more controlled points to generate controlled fluid flow and/or inflows. At least a portion of the data can be used to develop the model, and optionally, a portion of the data can be used to test the model once it is developed.

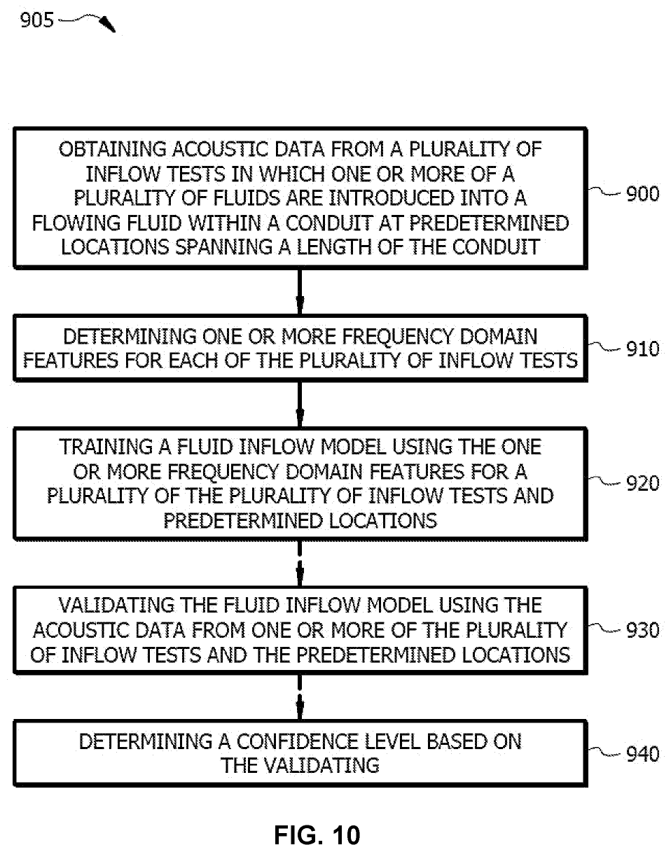

FIG. 10 illustrates a flow diagram of a method 905 of developing a fluid identification or flow model according to some embodiments (e.g., such as the model(s) discussed above for blocks 600, 700 of method 10). The method 905 can comprise, at 900, obtaining acoustic data or signals from a plurality of flow and/or inflow tests in which one or more fluids of a plurality of fluids are introduced into a conduit at predetermined locations spanning a length of the conduit, wherein the plurality of fluids comprise a hydrocarbon gas, a hydrocarbon liquid, an aqueous fluid, or a combination thereof, and wherein the acoustic signal comprises acoustic samples across a portion of the conduit. The one or more fluids of a plurality of fluids can be introduced into a flowing fluid to determine the inflow signatures for fluid(s) entering flow fluids. In some embodiments, the one or more fluids can be introduced in a relatively stagnant fluid. This may help to model the lower or lowest producing portion of the well where no bulk fluid flow may be passing through the wellbore at the point at which the fluid enters the well. This may be tested to obtain the signature of fluid inflow into a fluid within the wellbore that may not be flowing.

The acoustic signal can be obtained at 900 by any suitable method. In some embodiments, the acoustic data can be from field data where the data is verified by other test instruments. In some embodiments, the acoustic signal is obtained from a sensor within or coupled to the conduit for each inflow test of the plurality of inflow tests. The sensor can be disposed along the length of the conduit, and the acoustic signal that is obtained can be indicative of an acoustic source along a length of the conduit. The sensor can comprise a fiber optic cable disposed within the conduit, or in some embodiments, coupled to the conduit (e.g., on an outside of the conduit). The conduit can be a continuous section of a tubular, and in some embodiments, the can be disposed in a loop. While described as being a loop in some circumstances, a single section of pipe or tubular can also be used with additional piping used to return a portion of the fluid to the entrance of the conduit.

The configuration of the tubular test arrangement can be selected based on an expected operating configuration. A generic test arrangement may comprise a single tubular having one or more injection points. The acoustic sensor can be disposed within the tubular or coupled to an exterior of the tubular. In some embodiments, other arrangement such as pipe-in-pipe arrangements designed to mimic a production tubular in a casing string can be used for the flow tests. The sensor can be disposed within the inner pipe, in an annulus between the inner pipe and outer pipe, or coupled to an exterior of the outer pipe. The disposition of the sensor and the manner in which it is coupled within the test arrangement can be the same or similar to how it is expected to be disposed within a wellbore. Any number of testing arrangements and sensor placements can be used, thereby allowing for test data corresponding to an expected completion configuration. Over time, a library of configurations and resulting test data can be developed to allow for future models to be developed based on known, labeled data used to train models.

In some embodiments, the conduit comprises a flow loop, and the flowing fluid can selectively comprises an aqueous fluid, a hydrocarbon fluid, a gas, or a combination thereof. The flowing fluid can selectively comprise a liquid phase, a multi-phase mixed liquid, or a liquid-gas mixed phase. In some embodiments, the flowing fluid within the conduit can have a flow regime including, but not limited to, laminar flow, plugging flow, slugging flow, annular flow, turbulent flow, mist flow, bubble flow, or any combination thereof. Within these flow regimes, the flow and/or inflow can be time based. For example, a fluid inflow can be laminar over a first time interval followed by slugging flow over a second time period, followed by a return to laminar or turbulent flow over a third time period. Thus, the specific flow regimes can be interrelated and have periodic or non-periodic flow regime changes over time.

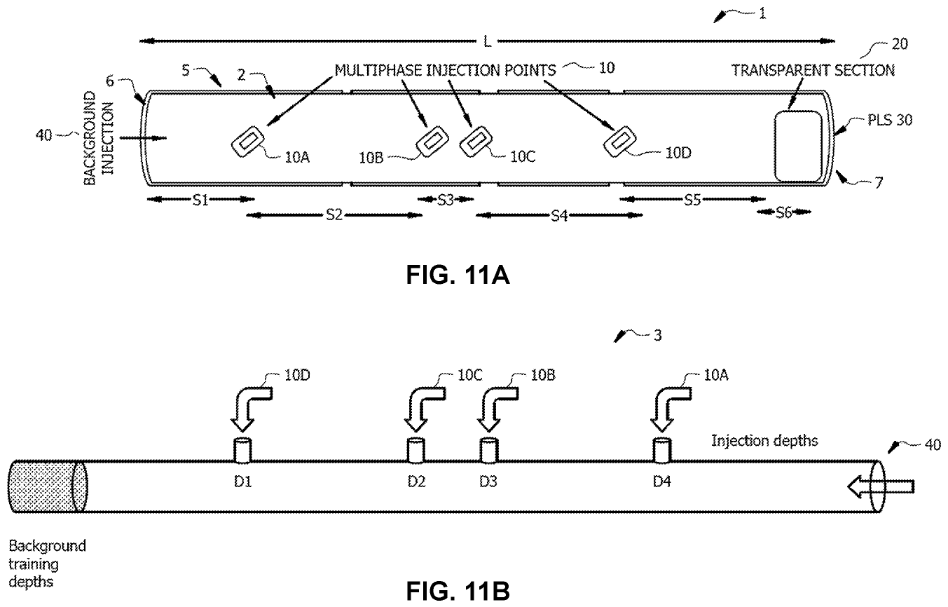

Referring now to FIG. 11 (including FIGS. 11A and 11B), an assembly 1 for performing inflow tests (e.g., such as those described herein for method 905) is shown. Assembly 1 comprises a conduit 5 into or onto which a sensor 2 (e.g., a fiber optic cable) is disposed. In some embodiments, the fiber optic cable 2 can be disposed within conduit 5. In some embodiments, the fiber optic cable 2 can be disposed along an outside of the conduit 5, for example, coupled to an exterior of the conduit. The fiber optic cable can be disposed along a length L of conduit 5. In some embodiments, other types of sensors can be used such as point source acoustic or vibration sensors. A line 40 may be configured for introducing background fluid into a first end 6 of conduit 5. One or a plurality of injection points 10 can be disposed along length L of conduit 5. An assembly for performing inflow tests can comprise any number of injection points. For example, an assembly for performing inflow tests according to this disclosure can comprise 1, 2, 3, 4, 5, 6, 7, 8, 9, 10, or more injection points 10. For example, in the embodiment of FIG. 11A, four injection points 10A, 10B, 10C, and 10D are disposed along length L of conduit 5. By way of example, a length L of conduit 5 may be in a range of from about 10 to about 100 meters, from about 20 to about 80 meters, or from about 30 to about 70 meters, for example, 30, 40, 45, 50, 55, 60, 65, or 70 meters.

The injection points may be positioned a spacing distance apart with regard to each other and/or first end 6 and second end 7 of conduit 5. The spacing distance can be selected based on a spatial resolution of the sensor system such that the injection points can be distinguished from each other in the resulting testing data. When point source sensors are used, the type of sensors can be considered in selecting the spacing distance. The spacing distance may also be selected, at least in part, to be sufficient to allow for a desired flow regime to develop between injection points. In some embodiments, first injection point 10A can be positioned a spacing distance S1 from first end 6 of conduit 5 and a second spacing S2 from second injection point 10B. Second injection point 10B can be positioned a spacing distance S3 from third injection point 10C. Third injection point 10C can be positioned a spacing distance S4 from a fourth injection point 10D. Fourth injection point 10D can be positioned a spacing distance S5 from a transparent section 20 of conduit 5. Transparent section 20 can be utilized to visually confirm the flow regime within conduit 5. The visual appearance information can be recorded as part of the test data set. A PLS may be positioned within a spacing distance S6 of second end 7 of conduit 5 and operable to compare data received via sensor or fiber optic cable 2. In some embodiments, without limitation, the spacing distances between injection points (e.g., spacing distances S2, S3, and S4) are in a range of from about 2 to about 20 m, from about 2 to about 15 m, or from about 10 m to about 15 m apart. In some embodiments, the first and last injection points are at least 5, 6, 7, 8, 9, or 10 m from a closest end (e.g., from first end 6 or second end 7) of conduit 5. For example, spacing distances S1 and S5 can be at least 5, 6, 7, 8, 9, or 10 meters, in some embodiments.

The conduit 5 can be disposed at any angle, including any angle between, and including, horizontal to vertical. The angle of the conduit, along with the fluid composition and flow rates can affect the flow regimes within the conduit. For example, a gas phase may collect along a top of a horizontally oriented conduit 5 as compared to a bubbling or slugging flow in a vertical conduit. Thus, the flow regime can change based on an orientation of the conduit even with the same fluid flow rates and compositions. The angle can be selected to represent those conditions that are being modeled to match those found in a wellbore, and the angle of the conduit can become part of the data obtained from the test set up.

Background fluid can be injected into line 40 in any of the flow regimes noted herein, for example, laminar flow, plugging flow, slugging flow, annular flow, turbulent flow, mist flow, and/or bubble flow, which may be visually confirmed through transparent section 20 of assembly 1. The background flowing fluid can comprise a liquid phase, a multi-phase mixed liquid, and/or a liquid-gas mixed phase. The inflow tests can include various combinations of injected fluid and background flowing fluid. For example, a single phase (e.g., water, gas, or hydrocarbon liquid) can be injected into a background fluid comprising one or multiple phases (e.g., water, gas, and/or hydrocarbon liquid) flowing in a particular flow regime. Inflow tests can also be performed for injection of multiphase fluids (e.g., hydrocarbon liquid and gas, hydrocarbon liquid and water, hydrocarbon liquid, water, and gas) into a background fluid comprising one or multiple phases (e.g., water, gas, and/or hydrocarbon liquid) flowing in a particular flow regime.

In order to understand the variability in the measured signal for testing purposes, the flow for each type of flow can be incremented over time. For example, the flow and/or injection rate can be varied in steps over a time period. Each rate of flow or injection rate can be held constant over a time period sufficient to obtain a useable sample data set. The time period should be sufficient to identify variability in the signal at a fixed rate. For example, between about 1 minute and about 30 minutes of data can be obtained at each stepped flow rate before changing the flow rate to a different flow or injection rate.

As depicted in the schematic of FIG. 11B, which is a schematic 3 showing wellbore depths corresponding to injection points of FIG. 8A, the inflow tests can be calibrated to a certain reservoir depth, for example, by adjusting the fiber optic signal for the test depth. For example, injection points 10A, 10B, 10C, and 10D can correspond to inflow depths D1, D2, D3, and D4, respectively. As an example, a length of fiber optic cable can be used that corresponds to typical wellbore depths (e.g., 3,000 m to 10,000 m, etc.). The resulting acoustic signals can then represent or be approximations of acoustic signals received under wellbore conditions. During the flow tests, acoustic data can be obtained under known flow conditions. The resulting acoustic data can then be used as training and/or test data for purposes of preparing the fluid flow model. For example, a first portion of the data can be used with machine learning techniques to train the fluid flow model, and a second portion of the data can be used to verify the results from the fluid flow model once it is developed.

Referring again to FIG. 10, in some embodiments, the test data obtained from the flow apparatus of FIG. 11 may be utilized to obtain the acoustic data at 900 for method 905. Next, method 905 may comprise determining one or more frequency domain features for each of the plurality of inflow tests at 910, and training the fluid flow model can use the one or more frequency domain features for a plurality of the tests and the predetermined locations at 920. The training of the fluid flow model can use machine learning, including any supervised or unsupervised learning approach. For example, the fluid flow model can be a neural network, a Bayesian network, a decision tree, a logistical regression model, a normalized logistical regression model, k-means clustering or the like.

In some embodiments, the fluid flow model can be developed and trained using a logistic regression model. As an example for training of a model used to determine the presence or absence of a hydrocarbon gas phase (e.g., such as discussed above for block 600 of method 10), the training of the fluid flow model at 920 can begin with providing the one or more frequency domain features (including any frequency domain features noted hereinabove as well as combinations, transformations, and/or variants thereof) to the logistic regression model corresponding to one or more inflow tests where the one or more fluids comprise a hydrocarbon gas. The one or more frequency domain features can be provided to the logistic regression model corresponding to one or more inflow tests where the one or more fluids do not comprise a hydrocarbon gas. A first multivariate model can be determined using the one or more frequency domain features as inputs. The first multivariate model can define a relationship between a presence and an absence of the hydrocarbon gas in the one or more fluids. A similar training protocol can be carried out to train the model (or other models) to define a relationship between a presence and absence of aqueous fluid and hydrocarbon liquids.

In addition, with respect to models used for classifying the amount (e.g., flow rate) of identified fluid types (e.g., such as discussed above for block 700 of method 10), training such a model at 920 may comprise providing one or more frequency domain features corresponding to the one or more inflow tests to the model (e.g., such as a logistic regression model as previously described). Known amounts or flow rates may be associated with the one or more frequency domain features that are provided to the model. Thus, the provided frequency domain features may be bucketed or separated into a plurality of flow rate ranges. Next, logistic regression can be applied to the frequency domain features within each flow rate range so as to build a function for a decision boundary that is dependent on two or more of the frequency domain features. During this process, different combinations of the frequency domain features may be utilized so as to determine which combination of frequency domain features yields a decision boundary that provides the highest level of determination accuracy for the given flow rate range. This process may be repeated for each identified or designated flow rate range for each type of fluid (e.g., gas, hydrocarbon liquid, aqueous fluid, etc.) so as to achieve a decision boundary for each flow rate range of the gas, hydrocarbon liquid, and aqueous fluid flows.

In the fluid flow model, the multivariate model equations can use the frequency domain features or combinations or transformations thereof to determine when a specific fluid, flow regime, and/or flow rate range is present. The multivariate model can define a threshold, decision point, and/or decision boundary having any type of shapes such as a point, line, surface, or envelope between the presence and absence of the specific fluid or flow regime. In some embodiments, the multivariate model can be in the form of a polynomial, though other representations are also possible. When models such as neural networks are used, the thresholds can be based on node thresholds within the model. As noted herein, the multivariate model is not limited to two dimensions (e.g., two frequency domain features or two variables representing transformed values from two or more frequency domain features), and rather can have any number of variables or dimensions in defining the threshold between the presence or absence of the fluid, flow regime, and/or flow rate range. When used, the detected values can be used in the multivariate model, and the calculated value can be compared to the model values. The presence of the fluid, flow regime, and/or flow rate range can be indicated when the calculated value is on one side of the threshold and the absence of the fluid, flow regime, and/or flow rate range can be indicated when the calculated value is on the other side of the threshold. Thus, each multivariate model can, in some embodiments, represent a specific determination between the presence or absence of a fluid, flow regime, and/or flow rate range. Different models, and therefore thresholds, can be used for each fluid and/or flow regime, and each multivariate model can rely on different frequency domain features or combinations or transformations of frequency domain features. Since the multivariate models define thresholds for the determination and/or identification of specific fluids, and/or different flow rate ranges for each specific fluid, the multivariate models and fluid flow model using such multivariate models can be considered to be event signatures for each type of fluid flow and/or inflow (including flow regimes, flow rate ranges, etc.).

Referring still to FIG. 10, once the model is trained or developed at 920, method 905 may proceed to validate or verify the fluid flow model(s) at 930. In some embodiments, the plurality of the tests used for training the fluid flow model at 920 can be a subset of the plurality of inflow tests from 900, and the tests used to validate the model(s) at 930 can be another subset of the plurality of flow tests from 900. In addition, in some embodiments the validation at 930 may be carried out using the acoustic signals from one or more tests and the predetermined locations of the one or more tests.

More specifically, with respect to models used for classifying the amount (e.g., flow rate) of identified fluid types (e,g., such as discussed above for block 700 of method 10), the validation at 930 can include providing the acoustic signals from one or more of the plurality of inflow tests (e.g., from 900) to the model(s). A presence or absence of flow rate ranges for the known type(s) of fluid flow associated with the acoustic signals (e.g., gas, aqueous, hydrocarbon liquid, etc.) can then be determined using the model(s). As a result, the flow rate classification model(s) can be validated by comparing the predicted presence or absence of the flow rate ranges in question to the actual flow rate ranges as known from the test data. Should the accuracy of the model(s) be sufficient (e.g., meeting a confidence threshold), then the fluid flow model can be used to detect and/or identify fluids within a wellbore. If the accuracy is not sufficient, then additional training or development (e.g., at 900, 910, 920) can be carried out to either find new frequency domain feature relationships to define the models or improve the derived models to more accurately predict the presence and identification of the flow rate ranges. In this process, the development, validation, and accuracy checking can be iteratively carried out until a suitable fluid flow rate model (or plurality of such models) is determined. Using the validation process, a confidence level can be determined based on the validating at 940.

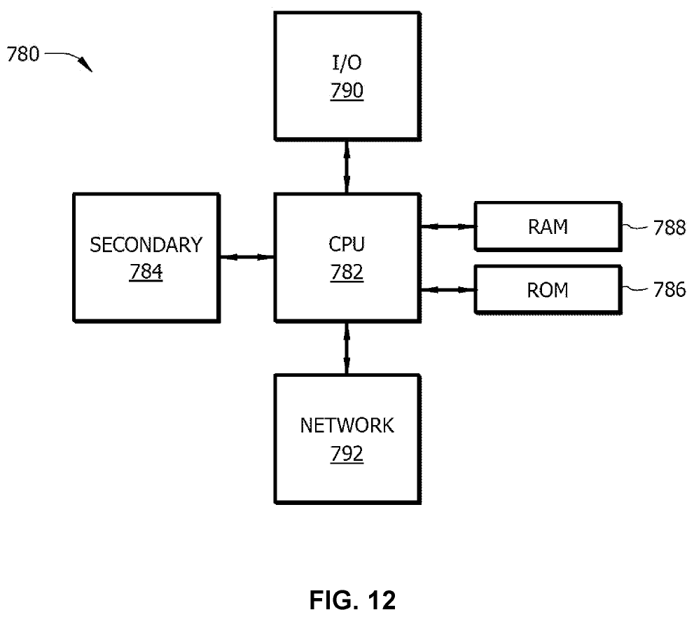

Any of the systems and methods disclosed herein can be carried out on a computer or other device comprising a processor (e.g., a desktop computer, a laptop computer, a tablet, a server, a smartphone, or some combination thereof), such as the acquisition device 160 of FIG. 2. FIG. 12 illustrates a computer system 780 suitable for implementing one or more embodiments disclosed herein such as the acquisition device or any portion thereof. The computer system 780 includes a processor 782 (which may be referred to as a central processor unit or CPU) that is in communication with memory devices including secondary storage 784, read only memory (ROM) 786, random access memory (RAM) 788, input/output (I/O) devices 790, and network connectivity devices 792. The processor 782 may be implemented as one or more CPU chips.

It is understood that by programming and/or loading executable instructions onto the computer system 780, at least one of the CPU 782, the RAM 788, and the ROM 786 are changed, transforming the computer system 780 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 780 is turned on or booted, the CPU 782 may execute a computer program or application. For example, the CPU 782 may execute software or firmware stored in the ROM 786 or stored in the RAM 788. In some cases, on boot and/or when the application is initiated, the CPU 782 may copy the application or portions of the application from the secondary storage 784 to the RAM 788 or to memory space within the CPU 782 itself, and the CPU 782 may then execute instructions of which the application is comprised. In some cases, the CPU 782 may copy the application or portions of the application from memory accessed via the network connectivity devices 792 or via the I/O devices 790 to the RAM 788 or to memory space within the CPU 782, and the CPU 782 may then execute instructions of which the application is comprised. During execution, an application may load instructions into the CPU 782, for example load some of the instructions of the application into a cache of the CPU 782. In some contexts, an application that is executed may be said to configure the CPU 782 to do something, e,g,, to configure the CPU 782 to perform the function or functions promoted by the subject application. When the CPU 782 is configured in this way by the application, the CPU 782 becomes a specific purpose computer or a specific purpose machine.

The secondary storage 784 is typically comprised of one or more disk drives or tape drives and is used for non-volatile storage of data and as an over-flow data storage device if RAM 788 is not large enough to hold all working data. Secondary storage 784 may be used to store programs which are loaded into RAM 788 when such programs are selected for execution. The ROM 786 is used to store instructions and perhaps data which are read during program execution. ROM 786 is a non-volatile memory device which typically has a small memory capacity relative to the larger memory capacity of secondary storage 784. The RAM 788 is used to store volatile data and perhaps to store instructions. Access to both ROM 786 and RAM 788 is typically faster than to secondary storage 784. The secondary storage 784, the RAM 788, and/or the ROM 786 may be referred to in some contexts as computer readable storage media and/or non-transitory computer readable media.

I/O devices 790 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 792 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 792 may enable the processor 782 to communicate with the Internet or one or more intranets. With such a network connection, it is contemplated that the processor 782 might receive information from the network, or might output information to the network (e.g., to an event database) in the course of performing the above-described method steps. Such information, which is often represented as a sequence of instructions to be executed using processor 782, may be received from and outputted to the network, for example, in the form of a computer data signal embodied in a carrier wave.

Such information, which may include data or instructions to be executed using processor 782 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 782 executes instructions, codes, computer programs, scripts which it accesses from hard disk, floppy disk, optical disk (these various disk based systems may all be considered secondary storage 784), flash drive, ROM 786, RAM 788, or the network connectivity devices 792. While only one processor 782 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 784, for example, hard drives, floppy disks, optical disks, and/or other device, the ROM 786, and/or the RAM 788 may be referred to in some contexts as non-transitory instructions and/or non-transitory information.

In an embodiment, the computer system 780 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 780 to provide the functionality of a number of servers that is not directly bound to the number of computers in the computer system 780. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 780, at least portions of the contents of the computer program product to the secondary storage 784, to the ROM 786, to the RAM 788, and/or to other non-volatile memory and volatile memory of the computer system 780. The processor 782 may process the executable instructions and/or data structures in part by directly accessing the computer program product, for example by reading from a CD-ROM disk inserted into a disk drive peripheral of the computer system 780. Alternatively, the processor 782 may process the executable instructions and/or data structures by remotely accessing the computer program product, for example by downloading the executable instructions and/or data structures from a remote server through the network connectivity devices 792. The computer program product may comprise instructions that promote the loading and/or copying of data, data structures, files, and/or executable instructions to the secondary storage 784, to the ROM 786, to the RAM 788, and/or to other non-volatile memory and volatile memory of the computer system 780.

In some contexts, the secondary storage 784, the ROM 786, and the RAM 788 may be referred to as a non-transitory computer readable medium or a computer readable storage media. A dynamic RAM embodiment of the RAM 788, likewise, may be referred to as a non-transitory computer readable medium in that while the dynamic RAM receives electrical power and is operated in accordance with its design, for example during a period of time during which the computer system 780 is turned on and operational, the dynamic RAM stores information that is written to it. Similarly, the processor 782 may comprise an internal RAM, an internal ROM, a cache memory, and/or other internal non-transitory storage blocks, sections, or components that may be referred to in some contexts as non-transitory computer readable media or computer readable storage media.

Having described various systems and methods herein, certain embodiments can include, but are not limited to:

In a first embodiment, a method of characterizing an inflow into a wellbore comprises: obtaining an acoustic signal from a sensor within the wellbore, wherein the acoustic signal comprises acoustic samples across a portion of a depth of the wellbore; determining a plurality of frequency domain features from the acoustic signal; identifying at least one of a gas phase flow, an aqueous phase flow, or a hydrocarbon liquid phase flow using the plurality of the frequency domain features; and classifying a flow rate of the at least one of the gas phase flow, the aqueous phase flow, or the hydrocarbon liquid phase flow using the plurality of frequency domain features.

A second embodiment can include the method of the first embodiment, wherein classifying the flow rate comprises classifying the flow rate of the at least one of the gas phase flow, the aqueous phase flow, or the hydrocarbon liquid phase flow into a plurality of predetermined flow rate ranges using the plurality of frequency domain features.

A third embodiment can include the method of the second embodiment, wherein the plurality of predetermined ranges comprises: a first flow rate range and a second flow rate range for the gas phase flow, wherein the second flow rate range is greater than the first flow rate range; a third flow rate range and a fourth flow rate range for the aqueous phase flow, wherein the fourth flow rate range is greater than the third flow rate range; and a fifth flow rate range and a sixth flow rate range for the hydrocarbon liquid phase flow, wherein the sixth flow rate range is greater than the fifth flow rate range.

A fourth embodiment can include the method of the third embodiment, wherein classifying the flow rate comprises: classifying the gas phase flow into the first flow rate range or the second flow rate range using the plurality of frequency domain features; classifying the aqueous phase flow into the third flow rate range or the fourth flow rate range using the plurality of frequency domain features; or classifying the hydrocarbon liquid phase flow into the fifth flow rate range or the sixth flow rate range using the plurality of frequency domain features.

A fifth embodiment can include the method of any one of the first to fourth embodiments, wherein classifying the flow rate comprises: determining whether the plurality of frequency domain features are on a first side or a second side of a decision boundary, wherein the decision boundary is dependent upon the plurality of frequency domain features; and classifying the flow rate of the at least one of the gas phase flow, the aqueous phase flow, and the hydrocarbon liquid phase flow based on the determination of whether the plurality of frequency domain features are on the first side or the second side of the decision boundary.

A sixth embodiment can include the method of any one of the first to fifth embodiments, wherein the plurality of frequency domain features comprises at least two different frequency domain features.

A seventh embodiment can include the method of any one of the second to sixth embodiments, further comprising: selecting a time window for the acoustic signal; determining a dominant flow rate range of the plurality of predetermined ranges for the at least one of the gas phase flow, the aqueous phase flow, or the hydrocarbon liquid phase flow over the time window; and setting the flow rate of the at least one of the gas phase flow, the aqueous phase flow, or the hydrocarbon liquid phase flow as a value or values associated with the dominant flow rate range for the time window.

An eighth embodiment can include the method of any one of the first to seventh embodiments, wherein the plurality of frequency domain features comprises at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof.

A ninth embodiment can include the method of any one of the first to eighth embodiments, wherein the sensor comprises a fiber optic cable disposed within the wellbore.

A tenth embodiment can include the method of any one of the first to ninth embodiments, further comprising denoising the acoustic signal prior to determining the plurality of frequency domain features.

An eleventh embodiment can include the method of the tenth embodiment, wherein denoising the acoustic signal comprises median filtering the acoustic data.

A twelfth embodiment can include the method of any one of the first to eleventh embodiments, further comprising normalizing the one or more frequency domain features prior to determining the plurality of frequency domain features.

A thirteenth embodiment can include the method of any one of the first to twelfth embodiments, further comprising: determining a remediation procedure based on the flow rate from classifying the flow rate; and performing the remediation procedure.

A fourteenth embodiment can include the method of any one of the first to thirteenth embodiments, wherein obtaining the acoustic signal from the sensor within the wellbore occurs from between 30 minutes and 4 hours.

In a fifteenth embodiment, a method of developing a fluid flow characterization model for a wellbore comprises: performing a plurality of flow tests, wherein each flow test comprises introducing one or more fluids of a plurality of fluids into a flowing fluid within a conduit, wherein the plurality of fluids comprise a hydrocarbon gas, a hydrocarbon liquid, and an aqueous fluid, or a combination thereof; obtaining an acoustic signal from a sensor within the conduit for each flow test of the plurality of flow tests, wherein the acoustic signal comprises acoustic samples across a portion of the conduit; determining one or more frequency domain features from the acoustic signal for each of the plurality of fluid flow tests; and training a fluid flow characterization model using the one or more frequency domain features, wherein the fluid flow characterization model comprises a classification model that is configured to classify a flow rate of the hydrocarbon gas, the hydrocarbon liquid, and the aqueous fluid using the one or more frequency domain features.

A sixteenth embodiment can include the method of the fifteenth embodiment, wherein the fluid flow characterization model is configured to classify the flow rate of the hydrocarbon gas, the hydrocarbon liquid, and the aqueous fluid into a plurality of predetermined ranges using the plurality of frequency domain features.

A seventeenth embodiment can include the method of the fifteenth or sixteenth embodiment, further comprising: determining a decision boundary that is dependent upon at least some of the plurality of frequency domain features; and classifying the flow rate of the hydrocarbon gas, the hydrocarbon liquid, and the aqueous fluid with the fluid flow characterization model based on the decision boundary.

An eighteenth embodiment can include the method of any one of the fifteenth to seventeenth embodiments, wherein the plurality of frequency domain features comprises at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof.

A nineteenth embodiment can include the method of any one of the fifteenth to eighteenth embodiments, wherein the conduit is disposed in a loop.

A twentieth embodiment can include the method of any one of the fifteenth to nineteenth embodiments, wherein the sensor comprises a fiber optic cable disposed within the conduit.

A twenty first embodiment can include the method of any one of the fifteenth to twentieth embodiments, wherein the flowing fluid within the conduit has a flow regime selected from the group consisting of: laminar flow, plugging flow, slugging flow, annular flow, turbulent flow, mist flow, and bubble flow.

A twenty second embodiment can include the method of any one of the fifteenth to twenty first embodiments, wherein the sensor is disposed along the length of the conduit, and wherein the acoustic signal is indicative of an acoustic source along a length of the conduit.

In a twenty third embodiment, a method of characterizing fluid inflow into a wellbore comprises: obtaining an acoustic signal from a sensor within the wellbore, wherein the acoustic signal comprises acoustic samples across a portion of a depth of the wellbore, and wherein at least one of a gas phase flow, an aqueous phase flow, or a hydrocarbon liquid phase flow are flowing within the wellbore; determining a plurality of frequency domain features from the acoustic signal; and characterizing a flow rate of the at least one of the gas phase flow, the aqueous phase flow, or the hydrocarbon liquid phase flow using the plurality of frequency domain features.

A twenty fourth embodiment can include the method of the twenty third embodiment, wherein characterizing the flow rate comprises classifying the flow rate of the at least one of the gas phase flow, the aqueous phase flow, or the hydrocarbon liquid phase flow into a plurality of predetermined flow rate ranges using the plurality of frequency domain features.

A twenty fifth embodiment can include the method of the twenty fourth embodiment, wherein the plurality of predetermined flow rate ranges comprises a first flow rate range and a second flow rate range for at least one of the gas phase flow, the aqueous phase flow, or the hydrocarbon liquid phase flow, wherein the second flow rate range is greater than the first flow rate range.

A twenty sixth embodiment can include the method of the twenty fifth embodiment, wherein characterizing the flow rate comprises: determining whether the plurality of frequency domain features are on a first side or a second side of a decision boundary, wherein the decision boundary is dependent upon at least some of the plurality of frequency domain features; and classifying the flow rate of the at least one of the gas phase flow, the aqueous phase flow, or the hydrocarbon liquid phase flow into the first flow rate range or the second flow rate range based on the determination of whether the plurality of frequency domain features are on the first side or the second side of a decision boundary.

A twenty seventh embodiment can include the method of any one of the twenty third to twenty sixth embodiments, further comprising: selecting a time window for the acoustic signal; determining a dominant flow rate range of the plurality of predetermined ranges for the at least one of the gas phase flow, the aqueous phase flow, and the hydrocarbon liquid phase flow over the time window; and setting the flow rate of the at least one of the gas phase flow, the aqueous phase flow, and the hydrocarbon liquid phase flow as a value or values associated with the dominant flow rate range for the time window.

A twenty eighth embodiment can include the method of any one of the twenty third to twenty seventh embodiments, wherein the plurality of frequency domain features comprises at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof.

A twenty ninth embodiment can include the method of any one of the twenty third to twenty eighth embodiments, wherein the sensor comprises a fiber optic cable disposed within the wellbore.

A thirtieth embodiment can include the method of the twenty third embodiment, wherein characterizing the flow rate comprises using a predictive model to determine the flow rate of the at least one of the gas phase flow, the aqueous phase flow, or the hydrocarbon liquid phase flow using the plurality of frequency domain features as inputs.

In a thirty first embodiment, a system for characterizing an inflow into a wellbore comprises: a sensor within the wellbore; and a controller coupled to the sensor, wherein the controller is configured to: obtain an acoustic signal from the sensor, wherein the acoustic signal comprises acoustic samples across a portion of a depth of the wellbore; determine a plurality of frequency domain features from the acoustic signal; identify at least one of a gas phase flow, an aqueous phase flow, or a hydrocarbon liquid phase flow using the plurality of the frequency domain features; and classify a flow rate of the at least one of the gas phase flow, the aqueous phase flow, or the hydrocarbon liquid phase flow using the plurality of frequency domain features.

A thirty second embodiment can include the system of the thirty first embodiment, wherein the controller is configured to classify the flow rate of the at least one of the gas phase flow, the aqueous phase flow, or the hydrocarbon liquid phase flow into a plurality of predetermined flow rate ranges using the plurality of frequency domain features.

A thirty third embodiment can include the system of the thirty second embodiment, wherein the plurality of predetermined ranges comprises: a first flow rate range and a second flow rate range for the gas phase flow, wherein the second flow rate range is greater than the first flow rate range; a third flow rate range and a fourth flow rate range for the aqueous phase flow, wherein the fourth flow rate range is greater than the third flow rate range; and a fifth flow rate range and a sixth flow rate range for the hydrocarbon liquid phase flow, wherein the sixth flow rate range is greater than the fifth flow rate range.

A thirty fourth embodiment can include the system of the thirty third embodiment, wherein the controller is configured to: classify the gas phase flow into the first flow rate range or the second flow rate range using the plurality of frequency domain features; classify the aqueous phase flow into the third flow rate range or the fourth flow rate range using the plurality of frequency domain features; or classify the hydrocarbon liquid phase flow into the fifth flow rate range or the sixth flow rate range using the plurality of frequency domain features.

A thirty fifth embodiment can include the system of any one of the thirty first to thirty fourth embodiments, wherein the controller is configured to: determine whether the plurality of frequency domain features are on a first side or a second side of a decision boundary, wherein the decision boundary is dependent upon the plurality of frequency domain features; and classify the flow rate of the at least one of the gas phase flow, the aqueous phase flow, and the hydrocarbon liquid phase flow based on whether the plurality of frequency domain feature are on the first side of the second side of the decision boundary.

A thirty sixth embodiment can include the system of any one of the thirty first to thirty fifth embodiments, wherein the controller is configured to: select a time window for the acoustic signal; determine a dominant flow rate range of the plurality of predetermined ranges for the at least one of the gas phase flow, the aqueous phase flow, or the hydrocarbon liquid phase flow over the time window; and set the flow rate of the at least one of the gas phase flow, the aqueous phase flow, or the hydrocarbon liquid phase flow as a value or values associated with the dominant flow rate range for the time window.

In a thirty seventh embodiment, a system for characterizing an inflow into a wellbore comprises: a sensor within the wellbore; and a controller coupled to the sensor, wherein the controller is configured to: obtain an acoustic signal from the sensor when at least one of a gas phase flow, an aqueous phase flow, or a hydrocarbon liquid phase flow are flowing within the wellbore, wherein the acoustic signal comprises acoustic samples across a portion of a depth of the wellbore; determine a plurality of frequency domain features from the acoustic signal; and classify a flow rate of the at least one of the gas phase flow, the aqueous phase flow, or the hydrocarbon liquid phase flow using the plurality of frequency domain features.

A thirty eighth embodiment can include the system of the thirty seventh embodiment, wherein the controller is configured to classify the flow rate of the at least one of the gas phase flow, the aqueous phase flow, or the hydrocarbon liquid phase flow into a plurality of predetermined flow rate ranges using the plurality of frequency domain features.

A thirty ninth embodiment can include the system of the thirty eighth embodiment, wherein the plurality of predetermined flow rate ranges comprises a first flow rate range and a second flow rate range for at least one of the gas phase flow, the aqueous phase flow, or the hydrocarbon liquid phase flow, wherein the second flow rate range is greater than the first flow rate range.

A fortieth embodiment can include the system of the thirty ninth embodiment, wherein the controller is configured to: determine whether the plurality of frequency domain features are on a first side or a second side of a decision boundary, wherein the decision boundary is dependent upon at least some of the plurality of frequency domain features; and classify the flow rate of the at least one of the gas phase flow, the aqueous phase flow, or the hydrocarbon liquid phase flow into the first flow rate range or the second flow rate range based on whether the plurality of frequency domain feature are on the first side of the second side of the decision boundary.

A forty first embodiment can include the system of ay one of the thirty seventh to fortieth embodiments, wherein the controller is configured to: select a time window for the acoustic signal; determine a dominant flow rate range of the plurality of predetermined ranges for the at least one of the gas phase flow, the aqueous phase flow, or the hydrocarbon liquid phase flow over the time window; and set the flow rate of the at least one of the gas phase flow, the aqueous phase flow, or the hydrocarbon liquid phase flow as a value or values associated with the dominant flow rate range for the time window.

In the manner described, embodiments described herein include systems and methods of continuously determining fluid inflow locations, as well as classifying the fluid type and flow rate within a hydrocarbon production well. Accordingly, through use of the systems and methods described herein, one may more effectively monitor the fluids flowing within a production well so as to better inform production operations throughout the producing life of the well.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method of characterizing an inflow into a wellbore, the method comprising:
obtaining an acoustic signal from a sensor within the wellbore, wherein the acoustic signal comprises acoustic samples across a portion of a depth of the wellbore;
determining a plurality of frequency domain features from the acoustic signal;
identifying at least one of a gas phase flow, an aqueous phase flow, or a hydrocarbon liquid phase flow using the plurality of the frequency domain features; and
classifying a flow rate of the identified at least one of the gas phase flow, the aqueous phase flow, or the hydrocarbon liquid phase flow using the plurality of frequency domain features, wherein classifying the flow rate comprises classifying the flow rate of the at least one of the gas phase flow, the aqueous phase flow, or the hydrocarbon liquid phase flow into a plurality of predetermined flow rate ranges using the plurality of frequency domain features.

2. The method of claim 1, wherein the plurality of predetermined ranges comprises:
a first flow rate range and a second flow rate range for the gas phase flow, wherein the second flow rate range is greater than the first flow rate range;
a third flow rate range and a fourth flow rate range for the aqueous phase flow, wherein the fourth flow rate range is greater than the third flow rate range; and
a fifth flow rate range and a sixth flow rate range for the hydrocarbon liquid phase flow, wherein the sixth flow rate range is greater than the fifth flow rate range.

3. The method of claim 2, wherein classifying the flow rate comprises:
classifying the gas phase flow into the first flow rate range or the second flow rate range using the plurality of frequency domain features;
classifying the aqueous phase flow into the third flow rate range or the fourth flow rate range using the plurality of frequency domain features; or
classifying the hydrocarbon liquid phase flow into the fifth flow rate range or the sixth flow rate range using the plurality of frequency domain features.

4. The method of claim 1, wherein classifying the flow rate comprises:
determining whether the plurality of frequency domain features are on a first side or a second side of a decision boundary, wherein the decision boundary is dependent upon the plurality of frequency domain features; and
classifying the flow rate of the at least one of the gas phase flow, the aqueous phase flow, and the hydrocarbon liquid phase flow based on the determination of whether the plurality of frequency domain features are on the first side or the second side of the decision boundary.

5. The method of claim 1, wherein the plurality of frequency domain features comprises at least two different frequency domain features.

6. The method of claim 1, comprising:
selecting a time window for the acoustic signal;
determining a dominant flow rate range of the plurality of predetermined ranges for the at least one of the gas phase flow, the aqueous phase flow, or the hydrocarbon liquid phase flow over the time window; and
setting the flow rate of the at least one of the gas phase flow, the aqueous phase flow, or the hydrocarbon liquid phase flow as a value or values associated with the dominant flow rate range for the time window.

7. The method of claim 1, wherein the plurality of frequency domain features comprises at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrela ion function, or a normalized variant thereof.

8. The method of claim 1, wherein the sensor comprises a fiber optic cable disposed within the wellbore.

9. The method of claim 1, further comprising denoising the acoustic signal prior to determining the plurality of frequency domain features.

10. The method of claim 9, wherein denoising the acoustic signal comprises median filtering the acoustic data.

11. The method of claim 1, further comprising normalizing the one or more frequency domain features prior to determining the plurality of frequency domain features.

12. The method of claim 1, further comprising:
determining a remediation procedure based on the flow rate from classifying the flow rate; and
performing the remediation procedure.

13. The method of claim 1, wherein obtaining the acoustic signal from the sensor within the wellbore occurs from between 30 minutes and 4 hours.

14. A method of characterizing fluid inflow into a wellbore, the method comprising:
obtaining an acoustic signal from a sensor within the wellbore, wherein the acoustic signal comprises acoustic samples across a portion of a depth of the wellbore, and wherein at least one of a gas phase flow, an aqueous phase flow, or a hydrocarbon liquid phase flow are flowing within the wellbore;
determining a plurality of frequency domain features from the acoustic signal; and
quantifying a flow rate of the at least one of the gas phase flow, the aqueous phase flow, or the hydrocarbon liquid phase flow using the plurality of frequency domain features, wherein quantifying the flow rate comprises classifying the flow rate of the at least one of the gas phase flow, the aqueous phase flow, or the hydrocarbon liquid phase flow into a plurality of predetermined flow rate ranges using the plurality of frequency domain features.

15. The method of claim 14, wherein the plurality of predetermined flow rate ranges comprises a first flow rate range and a second flow rate range for at least one of the gas phase flow, the aqueous phase flow, or the hydrocarbon liquid phase flow, wherein the second flow rate range is greater than the first flow rate range.

16. The method of claim 15, wherein characterizing the flow rate comprises:
determining whether the plurality of frequency domain features are on a first side or a second side of a decision boundary, wherein the decision boundary is dependent upon at least some of the plurality of frequency domain features; and
classifying the flow rate of the at least one of the gas phase flow, the aqueous phase flow, or the hydrocarbon liquid phase flow into the first flow rate range or the second flow rate range based on the determination of whether the plurality of frequency domain features are on the first side or the second side of a decision boundary.

17. The method of claim 14, comprising:
selecting a time window for the acoustic signal;
determining a dominant flow rate range of the plurality of predetermined ranges for the at least one of the gas phase flow, the aqueous phase flow, and the hydrocarbon liquid phase flow over the time window; and
setting the flow rate of the at least one of the gas phase flow, the aqueous phase flow, and the hydrocarbon liquid phase flow as a value or values associated with the dominant flow rate range for the time window.

18. The method of claim 14, wherein the plurality of frequency domain features comprises at least two of: a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, or a normalized variant thereof.

19. The method of claim 143, wherein the sensor comprises a fiber optic cable disposed within the wellbore.

20. The method of claim 14, wherein characterizing the flow rate comprises using a predictive model to determine the flow rate of the at least one of the gas phase flow, the aqueous phase flow, or the hydrocarbon liquid phase flow using the plurality of frequency domain features as inputs.

21. A system for characterizing an inflow into a wellbore, the system comprising:
a sensor within the wellbore; and
a controller coupled to the sensor, wherein the controller is configured to:
obtain an acoustic signal from the sensor when at least one of a gas phase flow, an aqueous phase flow, or a hydrocarbon liquid phase flow are flowing within the wellbore, wherein the acoustic signal comprises acoustic samples across a portion of a depth of the wellbore;
determine a plurality of frequency domain features from the acoustic signal; and
classify a flow rate of the at least one of the gas phase flow, the aqueous phase flow, or the hydrocarbon liquid phase flow using the plurality of frequency domain features, wherein the controller is configured to classify the flow rate of the at least one of the gas phase flow, the aqueous phase flow, or the hydrocarbon liquid phase flow into a plurality of predetermined flow rate ranges using the plurality of frequency domain features.

22. The system of claim 21, wherein the plurality of predetermined flow rate ranges comprises a first flow rate range and a second flow rate range for at least one of the gas phase flow, the aqueous phase flow, or the hydrocarbon liquid phase flow, wherein the second flow rate range is greater than the first flow rate range.

23. The system of claim 22, wherein the controller is configured to:
determine whether the plurality of frequency domain features are on a first side or a second side of a decision boundary, wherein the decision boundary is dependent upon at least some of the plurality of frequency domain features; and
classify the flow rate of the at least one of the gas phase flow, the aqueous phase flow, or the hydrocarbon liquid phase flow into the first flow rate range or the second flow rate range based on whether the plurality of frequency domain feature are on the first side of the second side of the decision boundary.

24. The system of claim 21, wherein the controller is configured to:
select a time window for the acoustic signal;
determine a dominant flow rate range of the plurality of predetermined ranges for the at least one of the gas phase flow, the aqueous phase flow, or the hydrocarbon liquid phase flow over the time window; and
set the flow rate of the at least one of the gas phase flow, the aqueous phase flow, or the hydrocarbon liquid phase flow as a value or values associated with the dominant flow rate range for the time window.
